(19) United States
(12) Patent Application Publication
(10) Pub. No.: US 2008/0052539 A1
(43) Pub. Date: Feb. 28, 2008

(54) Inline storage protection and key devices

(76) Inventors: David M. MacMillan, Mineral Point, WI (US); Carl Ross, Arbuckle, CA (US)

Correspondence Address: David M. MacMillan, 2526 Wearne Road, Mineral Point, WI, 53565, US

(21) Appl. No.: 11/881,643

(22) Filed: Jul. 26, 2007

Related U.S. Application Data
(60) Provisional application No. 60/834,123, filed on Jul. 29, 2006.

(51) Int. Cl. G06F 12/14

(52) U.S. Cl. 713/193

(57) ABSTRACT

A generalized-topology heterogeneous time-variant computing environment (CE) is defined, which includes generalized Usage Devices (UDs), Storage Devices (SDs), and Data Links (DLs). It includes as SDs all physical or virtual devices which may be used to store data and on which data may be accessed via an Access Protocol (AP), including devices of types not conventionally recognized as SDs. An Inline Storage Protection Device (ISPD) is defined, which is enabled for use by a physically distinct ISPD Key device (ISPDK) which must be removed after enablement. An ISPD protects using encryption the data on an SD associated with it, and simultaneously it applies data usage Policy and performs Auditing of data usage. In another operating scenario, an ISPD may function as a simple data protection device without applying Policy or performing Auditing, but in such operation excluding particular types of SDs addressed by similar devices in the prior art. In another operating scenario, an ISPD of either type maintains its SD as equivalent in content to an SD supplied by an external Coordinating Storage facility. In this usage multiple ISPDs in multiple CEs may coordinate against a single Coordinating Storage facility and thus maintain effectively identical SDs, each of which is protected independently of the others by its ISPD.

### SEQUENCE LISTING OR PROGRAM

Not Applicable

### BACKGROUND OF THE INVENTION

1. Field of Invention

This invention relates to the security of the storage of data and to the security, authorization, and auditing of the use and of the modification of stored data in a computing system or environment of general topology.

2. Terminology

This invention may be applied in a single, logically unified, manner to several superficially different portions of a computing system or distributed networked computing environment, including several portions which are in fact data storage devices but which in the established terminology of the art often are not recognized explicitly as data storage devices. In order to understand both the invention and the prior art, it is therefore useful to introduce a specific terminology.

The terminology so developed here differs in a number of ways from the less consistent terminology which has evolved historically within the art, but it possesses advantages of greater consistency and clarity. As it differs from that used generally, in most of the following definitions one or more examples from actual practice will be given. In each case, these examples are solely illustrative, not normative. Moreover, while the terminology here is intended to be consistent within itself, the names of systems and devices used in the examples will be those common within the art.

Note: The term “data” is in origin a plural form (the singular is “datum”). However, usage in the art and in common language has transformed this term into one which is both singular and plural. In accordance with this now common usage, “data” will be used as both a singular and a plural term in this document.

Term “Computing Environment” (“CE”)

It is a premise of this invention that from a logical point of view a “computer” is in principle not a single entity or device but instead is a structured and possibly varying set of heterogeneous devices interacting in an arbitrary, potentially distributed, and potentially dynamic or time-variant topology. It is therefore not satisfactory to speak separately of “a computer” or “a network” as if they were distinct within themselves and/or from each other. Instead, it is more useful to speak of a “Computing Environment” (“CE”). Although this is new terminology, this is not a new development in computing. It has always been the case logically and in fact has been reflected in the implementation of many computer systems and networks from early historical systems to contemporary computing systems.

For an example of thinking of a computing environment as a heterogeneous time-varient topology at the dawn of the modern computer age, see Vannevar Bush's article “As We May Think” describing his “Memex” system (Bush 1945). Since then there has been an extensive literature, and indeed an entire professional specialization, in distributed computer architectures. This literature is simply too large to cite; distributed computer architectures are now commonplace. The cutting edge of this research, however, is ill-documented as it appears to be conducted primarily by the “adversarial” (often “black hat”) computer security community. So for example, in a virtual extension of the mercury delay line storage device of the UNIVAC 1 computer of Eckert and Mauchly (1951), the transmission latency of the public Internet itself, something that might ordinarily be considered only as an ephermeral characteristic of a network, has now been used as a data storage device (see the topic “Parasitic Storage, pp. 232-242 in (Zalewski 2005) and (Zalewski and Purczyniski 2003)). Certainly the latency of the public Internet, which is a characteristic of a complex system, is a different type of engineering object from a conventional magentic hard disk drive, yet in this situation it can be made to perform the same function. It is no longer possible, if indeed it ever really was, to maintain a traditional notion of a computer as a unified machine constructed of more or less integrated physical components.

The term “Computing Environment” is not so fluid, however, that it simply designates the totality of all the world's computing hardware and software. While a single Computing Environment (CE) may itself be a distributed, networked entity, it remains an entity logically distinct from other Computing Environments, with which it may communicate and otherwise interact. Multiple distinct computing environments may however share access to one or more components. Thus, for example, two conventional computers may each access a single common storage device, yet each computer retains its own identity. (For a common example, see the use of Network File Systems (Sun 1989, Sun 2003)). This is relevant for the present invention because some modes of its operation do indeed involve the interaction of multiple, distinct Computing Environments which may share single components.

Term: “Basic Usage-Storage Model” (“BM”)

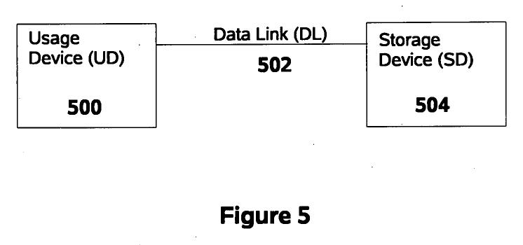

Regardless of the complexity of a Computing Environment, those aspects of a Computing Environment which are relevant to this invention may be reduced to the repeated application of a single simple model. This model will be termed the “Basic Usage-Storage Model,” or more simply just the “Basic Model” (“BM”) This model is shown diagrammatically in FIG. 5. The items enumerated in FIG. 5 are termed the Usage Device 500, the Data Link 502, and the Storage Device 504. These terms will be described below.

Terms: “Storage Device” and “Access Protocol”

In this Basic Model as shown in FIG. 5, the device 504 on the right is a “Storage Device” (“SD”) which stores digital data. For simplicity in presentation in this figure, it is shown here as a unitary device, but as will be elaborated later it may in fact be an arbitrarily complex set of full or partial devices. If it is such a composite device, then it may itself be further analyzed into instances of the Basic Model.

The defining external characteristic of an SD is that it can receive and provide data under the operational control of an “Access Protocol” (“AP”) and that it can retain the data that it holds for some useful period of time.

A Computing Environment may contain one or more SDs without limit.

Examples of SDs common in the art include (using names for them also common in the art): processor registers, Random Access Memory (RAM), areas of RAM in distributed (Memory Channel) and Non-Uniform Memory Access (NUMA) memory systems, magnetic or optical disks, (currently obsolete) magnetic drum storage, and other Direct Access Storage Devices (DASD), “RAID” arrays of magnetic disks, magnetic tape, “Mass Storage” arrays of magnetic tape, Network-Attached Storage (NAS) devices, punched cards and their readers/writers, Network File Systems and their servers, relational databases and their servers, certain aspects of World Wide Web documents and their servers, “parasitic” storage over network latencies as noted earlier, and so forth. All of these devices, and others, are at least well known and often common in the literature and in the marketplace.

SDs may be implemented as single devices or as composite devices. Unlike the possibly composite nature of Usage Devices (UDs; to be discussed below), which is not relevant to this invention, the possibly composite nature of SDs is relevant to this invention. Examples of composite SDs include: Non-Uniform Memory Access (NUMA) memory systems, RAID disk arrays configured for RAID Level 5 operation, Storage Area Networks, and so forth.

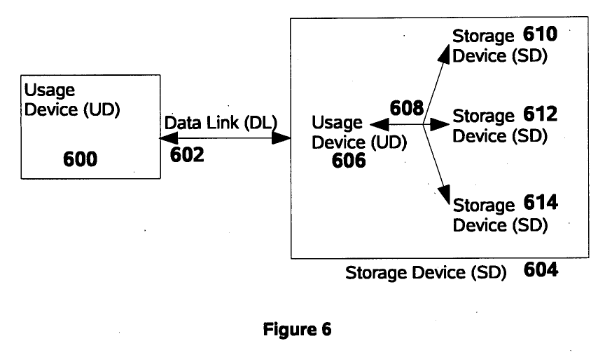

FIG. 6 illustrates the use of the Basic Model to describe a composite Storage Device. In this figure, device 600 is a Usage Device (UD) and device 602 is a Data Link (DL), as in the Basic Model. Device 604 is a Storage Device (SD), as in the Basic Model, but here it is internally a composite device which itself may be represented by the Basic Model. Within this composite device, 606 is a Usage Device (UD), 608 are Data Links (DLs), and 610, 612, and 614 are Storage Devices (SDs). For example, the Usage Device 606 might be a RAID storage controller, the Data Links 608 might be a SCSI bus, and the Storage Devices 610, 612, and 614 might be magnetic disks. As a different example, the Usage Device 606 might be a distributed memory controller, the Data Links 608 might be a gigabit Ethernet network, and the Storage Devices 610, 612, and 614 might be RAM.

SDs and components of composite SDs may also be “virtual” in the sense that they may be provided within the Computing Environment by other components of the Computing Environment which would not otherwise be considered SDs of the type virtualized, or provided by other Computing Environments entirely (where their underlying implementation is in general unknown to or irrelevant to the Usage Device). Examples of virtual SDs include: virtual memory (virtual RAM) implemented on disk (see (FSI 1992ff)), NFS network filesystems implemented over arbitrary networks to other Computing Environments (Sun 1989, Sun 2003), Document Object Model (DOM; see W3C DOM 1 1998)) access to documents served via HTTP over TCP/IP networks (which constitute a structured network-based storage, often a structured network-based “read-only memory” or “ROM”), “parasitic” storage over network latencies, and so forth.

Some of these SDs, such as magnetic disks, are commonly thought of as conventional storage devices in the art. Others, such as processor registers, are commonly thought of as storage devices but of a different type. Still others, such as documents served on the World Wide Web, are not commonly thought of as storage devices at all. Nevertheless, each of these SDs meets the criteria defining an SD as described above. Note that this invention is independent of traditional divisions of data access in terms of “memory access,” “block level I/O,” “file level I/O,” “web serving,” and the like. It requires only that a well-defined AP exist.

Note that while in the general case an SD both provides and receives data, situations exist where an SD might only provide data (for example, a memory location hardwired to the system clock) or receive data (for example, a write-only off-site backup device).

Term: “Usage Device”

In this Basic Model as shown in FIG. 5, the device 500 on the left is a “Usage Device” (“UD”) which may use data received from the SD and which may provide data to the SD. The UD may also interact arbitrarily with other components of the Computing Environment (such as display devices, communication devices, audio devices, environmental sensors, and so forth), in ways not relevant to this invention.

The UD may be a computational device. Examples of UDs as computational devices include: Arithmetic and Logic Units (ALUs) of many computer architectures, Input/Output device controllers capable of Direct Memory Access (DMA), memory-mapped video display units, and so forth.

The UD may also be another SD, in conjunction with appropriate hardware and/or software logic to enable its use as a UD. Examples of UDs which are SDs include: processor registers (UD) using data from RAM (SD), RAM (UD) buffering data to and from disk (SD), Virtual Memory (UD) using RAM (SD) and paging to disk (SD), disk (UD) buffering data from tape (SD), and so forth.

A Computing Environment may contain one or more UDs without limit.

The number of UDs and their topological configuration may change over time. (For example, in a “multiprocessor” computer it is common practice to allow processors to be added or removed “hot,” to use the terminology common in the art.) The type, number, and topology of the UDs of a Computing Environment are external to this invention. All that is required for this invention is that for each SD there exist at least one UD connected to it by at least one Data Link (“DL,” as discussed below). This must be the case even if the UD is another SD being used as a UD (as described above, and as, for example, in the case of a tape drive (SD) being buffered to disk (an SD functioning as a UD).

Term: “Data Element”

A Data Element (“DE”) is the unit of digital storage handled as a single encrypted entity by the “Inline Storage Protection Device” (“ISPD”) to be described in this invention. A DE may, but need not, correspond, and in practice often will not correspond, exactly with any minimum storage unit of the Storage Device's Access Protocol. For example, a Storage Device such as a magnetic disk might employ 512 byte blocks as its minimal storage unit, while an ISPD protecting that SD might be implemented so as to encrypt 16 blocks (for example) as its Data Element.

Term: “Data Link”

In this “basic model,” SDs and UDs are connected by one or more “data links” (DLs). Examples of DLs: intra-CPU semiconductor wiring, microprocessor memory busses, general purpose server busses such as PCI, I/O busses such as System/360 or successor mainframe computer architecture “channels” or the standard Universal Serial Bus (USB), network fabrics such as Ethernet (e.g., for “Network Attached Storage”), TCP/IP intranets and the public Internet, wireless communications networks, and so forth.

Note that the term “Data Link” as used here simply indicates a data/communications link in general terms. It does not have the specific connotations of the similar term in the International Organization for Standardization's (ISO's) Open Systems Interconnection (OSI) Basic Reference Model.

Term: “Cache”

A “cache” is in general a temporary collection of data from another source maintained to expedite the use of that data. The term is common in the art, and caches are ubiquitous throughout the art.

A “cache” may be implemented in either of two distinct manners, when considered with regard to SDs. The distinction between these two manners is relevant to this invention.

A Computing Environment, or software using a Computing Environment, may maintain a cache in one SD of data from another. Examples of this include: caching data from disk in RAM, caching data from tape into disk, and so forth. For the purposes of this invention, this type of caching may be considered simply another use of the SD in question, and is not relevant to this invention.

A Computing Environment may also include separate cache devices which are placed, topologically, between an SD and a UD. These caches contain data from the SD or data to be transferred to the SD. Since the purpose of a cache is to store data temporarily for the UD, caches are usually implemented in technologies which suit the UD more than the SD (for example, using faster storage technologies than the SD), and as such are often thought of as being “closer,” topologically, to the UD. This is not in fact the case logically, however. A cache of this sort is designed so that it is invisible to the UD (it is said to be “transparent” to the UD), and is thus logically a part of the SD.

Examples of caches of this type include: so-called “L2” processor caches caching RAM for processor use in IA32 architecture processors, conventional disk controller caches, and so forth.

In the discussion of this invention to follow, the placement of this invention with respect to this type of cache is significant.

A composite SD may also include caches between its plural components. If this occurs, one of the components is acting as a UD, and therefore these caches act in the same way as all other UD-to-SD caches. Examples of caches of this type include: caches between server memory distributed over a network, caches within Storage Area Networks, and so forth. In the discussion of this invention to follow, the placement of this invention with respect to this type of cache is significant.

(As an aid to clarity, the next set of term definitions, which covers the terms used to classify SDs, begins on a new page.)

Terms for the Classification of Storage Devices by Type of Access Protocol:

SDs may be grouped into classes on the basis of the information-theoretic nature of the way in which they are accessed. Such an approach has two broad benefits.

First, such a classification is more useful than traditional classifications based on implementation technology (e.g., RAM, disk, etc.) because it classifies at a logical level independent of changes in the underlying technology, because it can distinguish between classes of SDs which employ similar technologies, and because it can differentiate between SDs which are logically dissimilar although implemented in identical technologies.

Second, such a classification is more useful than traditional classifications based on logical implementation details (e.g., “block I/O,” “character I/O,” “file I/O,” “document serving,” etc.) because it provides a unified picture of SD access over an extremely broad spectrum of device types.

This invention does not depend upon one particular, or indeed on any given, SD classification or SD access protocol. It may be constructed so as to use any or all access protocols in any access classification indifferently. However, an understanding of SDs by access classification is useful in understanding the practical deployment of the invention.

The following classifications of access protocols will be distinguished:

Dedicated
Single-Port
Sequential
Random or Direct
Hierarchical or Tree Structured
Relational
Other

The SDs classifications enumerated here provide a comprehensive but not necessarily exhaustive survey of SDs as used in the art, and as such is sufficient to allow the description of the use of this invention in many practical contexts. This invention is not, however, tied to any particular SD, but, as its flexibly use with all of the types here enumerated illustrates, is independent of the type of SD.

The fact that an SD of some type not here enumerated, whether now known or hereafter invented, should not be taken to mean that the present invention is not intended for use with it.

SD Classification Term: Dedicated Access Storage Devices (“DedASD”)

A Dedicated Access SD is an SD which provides a single data location. While this might at first appear excessively limited, such devices are in fact quite common. Examples include the “accumulator” of traditional microprocessor architectures and any processor architecture where certain instructions are hardwired to particular registers. Examples of read-only dedicated storage include hardware real-time clocks, locations containing serial number or other fixed data, and the like. These storage types are common in many existing computer architectures, such as the International Business Machines Corporation's System/360 mainframe computer architecture and its successor architectures to the present day IBM z/Architecture mainframe computer architecture.

In the terminology adopted here, these will be called “DedASD” so as not to cause confusion with Direct Access Storage Devices (“DASD”), a term described below which is also a term common in the art.

SD Classification Term: Single-Port Access Storage Devices (“SPASD”)

Single-Port Access SDs read and write from and to a single known location, as do DedASDs, but whereas the behavior of a DedASD was that of the simple storage of or retrieval of a value, SPASD may store arbitrarily many values and the behavior of a SPASD depends upon an algorithm characteristic of the device. Common algorithms well-known in the art include Last-In-First-Out data structures (in which case the SPASD is commonly known as a “stack”) and First-In-First-Out data structures (in which case it is known as a “queue”). The stack and queue structures are basic topics in elementary computer science. The size of the data values stored in a SPASD arbitrary, and may be constant or variable within any given SPASD.

Examples of SPASD include the processor memory stack of the Burroughs Corporation B5000 computer of 1961 and its successors, the mercury delay lines used in some early computing machinery, the public Internet used as a “parasitic” data-storage device ((Zalewski and Purczynski 2003) and (Zalewski 2005)), circular queues used in magnetic bubble memories, and the print buffer of many printers (which is an SD, not a cache, written to by one UD (the computing system wishing to print) and read from by another UD (the printer's computing facilities)).

SD Classification Term: Sequential Access Storage Devices (“SASD”)

Sequential Access Storage Devices may also store an arbitrary quantity of data, but unlike SPASD they permit the UD to specify which item of data is to be read or written. The size of this item of data is arbitrary, and may be constant or variable within any given SASD. However SASD assume a linear or sequential organization of the data upon some medium, either physical or virtual. In the case of physical SASD, this may impose performance limitations upon them. Virtual SASD, even if they escape these performance limitations, are still subject to the logical limitations of a sequential medium.

Examples of SASD include the theoretical tape of a Turing Machine, magnetic tape, paper tape, decks of punched cards, “Mass Storage System” (MSS) arrays of magnetic tape, and magnetic tape emulated on other kinds of SDs. (such as DASD; see below).

SD Classification Term: Random or Direct Access Storage Devices (“RASD” or “DASD”)

Random Access Storage Devices (RASD) and Direct Access Storage Devices (DASD) both store arbitrary quantities of data and both allow access to arbitrary data locations within their storage. In both, the data location size may be fixed or variable. They differ in the relationship of the size of the storage location to the size of the storage location preferred by the UD.

RASD have a storage location size which tends closely to approximate the size preferred by the UD. Examples of RASD include, most prominently, the Random Access Memory (RAM) of conventional contemporary computers. This RAM typically is addressable in units which are nearly the size of the registers of the processor, or which are simple divisors or multiples of this size.

Perhaps less obviously, examples of RASD also include processor registers in processor architectures where registers are specified rather than assumed. Many processor architectures include both registers and/or accumulators which are dedicated (DedASD) and others which are addressable (RASD). Logically, however, and for the purposes of this invention, these two types of storage are distinct.

Making this distinction between DedASD and RASD also eliminates a potential conflation of two types of storage access. Expressed in the terminology of the art, certain system architectures allow both the direct manipulation of “registers” and the direct manipulation of “RAM.” If these are seen as separate types of storage—and they are commonly implemented using different technologies—then it would appear that there might be a confusion in identifying the UD to SD paths. A device placed between the computational core of the processor and its registers, for example (as might be done with this invention) would not necessarily have access to the RAM. Given the distinctions made here, however, this potential confusion resolves into a simple situation where there are two separate RASDs, one for the “registers” and another for the “RAM.”

DASD, by way of contrast to RASD, have a storage location size which tends to be larger than the size preferred by the UD. Typically this requires data from DASD to be staged to other SD, such as RASD, for use.

Examples of DASD include: magnetic disk, optical disk, magnetic drum, Network Attached Storage (NAS) providing virtual disks, RAID arrays of magnetic disks, and the like.

SD Classification Term: Hierarchical or Tree-Structured Access Storage Devices (“TASD”)

Hierarchical or Tree-Structured Access Storage Devices (TASD), though extremly common, often are not perceived as SDs. They have all of the characteristics of an SD, however: they store data, they allow data to be addressed according to a definite scheme, they allow data to be read, and to be written. The size of the data locations in a TASD may be fixed or variable.

The most common example of a TASD is a hierarchical filesystem. If implemented as a software construct on a single underlying DASD (or indeed virtual DASD or virtual RAID DASD), the TASD becomes simply a virtual SD. As such, for the purposes of this invention, it may be handled directly, or it may be ignored and the underlying SD may be handled.

A physical implementation of a TASD is certainly possible, although such devices are not common.

However, other types of virtual TASD which employ underlying media which are entirely opaque to the computing system are common; these are logically indistiguishable from physical devices. An example of such a virtual TASD best considered simply as a device is an NFS filesystem. Such a TASD is addressable (via hierarchical addresses, in this case path names), and support read and write operations. Yet the underlying implementation of an NFS filesystem is as opaque to the Computing Environment using it as are the electrical details of a traditional magnetic disk drive.

Other “virtual” TASD best considered simply as devices include documents served on the World Wide Web as interpreted via the Document Object Model (“DOM”). (See (W3C DOM 1 1998) and related World Wide Web Consortium documents.) These also have an underlying implementation opaque to the UD. They allow hierarchical access to individual data fields within the document. (While for reasons of security this is often read-only access, making them structured network “read-only-memory” devices, this read-only behavior is not inherent in Access Protocol of this type of TASD (that is, in HTTP and DOM) and TASD of this and other forms may be constructed which are read/write.)

Classification Term Relational Access Storage Devices (“RelASD”)

Relational Access Storage Devices (RelASD) are simply relational databases.

They share many operational features with TASD: when implemented within a Computing Environment using another type of SD, they may be handled directly or ignored in favor of the underlying SD. They may be built directly as physical devices. They are commonly also available as virtual devices provided by opaque implementations which are best considered simply as RelASD. One canonical overview of database technology is (Date 1975) (and later editions). See also the documentation for the MySQL relational database system (MySQL 1997).

### PRIOR ART

Prior Art: Threat Analysis.

As this invention has to do with data security, it must be understood in terms of possible threats to data security, some of which this invention is intended to address and others of which it is not.

In order properly to understand a threat, one must understand the adversary who or which presents the threat. One must also understand why and for whose benefit the threatened data are being protected.

Commonly the adversary against whom this protection is directed is seen to be an external entity. A SD such as a hard disk might, for example, contain important data that a business competitor or a foreign government might desire. This disk may be protected, in part, against such an external adversary by encrypting it. This is common in the prior art.

However, it is often the case that the most dangerous adversary against whom data must be protected is not an external adversary, but is in fact the legitimate user of the data. An employee of a business, or an agent of a government, for example, might legitimately have need to use the data on an SD for their work, yet might not be trusted completely. The purpose of protecting data is to protect it for the benefit of the owner of the data (for example, a private employer or a government agency). The owner of the data is often not the same entity as the user of the data. For example, a private business might have a large database of customers. The business itself (acting through its management) is the owner of this data. Clearly a business should protect this data against external threats, such as competitors who might derive advantage from it. Employees of the business, such as salespeople, have legitimate need to use this database of customers. However, a business might well not trust its employees to keep this data secure and not otherwise to misuse it. An employee might steal the database wholesale and sell it to a competitor, or upload false or misleading data into the database, or mistakenly access data forbidden to the employee. Particularly difficult situations arise when an employee's right to access data changes over time. For example, an accountant newly hired at an accounting firm might initially have legitimate access to all customer data. At some point when that accountant begins working with customer X, however, it may be desirable to ensure that they no longer have access to the data associated with customer Y (a competitor to customer X). Indeed, an organization may well have a legal need to ensure that its employees or agents do not access particular data, and an organization may suffer serious harm if, mistakenly or maliciously, they do. A disk encryption system from the prior art which successfully protects the firm's database against external adversaries does nothing to address such an issue.

One of the objects of the present invention is to allow simultaneously for the protection of data against threats from external adversaries and threats from otherwise legitimate or “internal” users. Although these adversaries differ, an “Inline Storage Protection Device” (ISPD) as described in this invention is well located to address them both.

Threat Types:

Security threats to a Computing Environment may take many general forms.

Some categories of threats do not concern the Basic Model described here. For example, a sensor (not a part of the Basic Model) may be subverted (e.g., a thief may put a cloth over a digital security camera). Such threats are not relevant to this invention.

Other categories of threats concern only the Usage Device. For example, a calculating circuit of some kind might be tampered with so as systematically to skew results. While these threats concern one element of the Basic Model, the UD, they are not relevant to this invention.

The security threats which are relevant to this invention involve the SD and access to the SD. These may be of five kinds:
1. Access to the SD can be denied or hindered
2. Data on the SD can become exposed (non-private)
3. Existing data on the SD can be falsified
4. Data on the SD can be destroyed
5. Data on the SD can be used inappropriately

Additionally, one of the modes of operation of the present invention involves the use of multiple Computing Environments communicating with a single SD. In this mode of operation, an additional threat exists:
6. Data on the SD may be caused to appear non-uniformly to the participants.

In each of these six situation, the adversary may be a conventional external adversary or an untrusted but otherwise legitimate user (an “internal” adversary). Note again that the user of the SD/data is not necessarily the owner of that data.

Threat Type 1. Access denied or hindered

The first kind of threat is an example of the general class of security threats known as “denials of service.” This invention does not address this threat or in general denial of service attacks. An attacker wishing to deny service may always simply steal the components of this invention and the SD they protect, in their entirety.

This invention does address the other kinds of threats.

Threat Type 2: Exposure

The exposure of data on the SD to an external adversary is addressed by the encryption techniques used by the invention, to be described. The exposure of data on the SD to an internal adversary is only partly preventable (because by definition a legitimate user of data must be able to use at least some of the data), but is addressed by the “Policy” and Auditing aspects of the present invention.

Threat Types 3 and 4: Falsification

The third and fourth kinds of threats, the falsification of data on the SD or the introduction of false data onto the SD, are addressed for external adversaries by the “Basic Read/Write Cycles” of this invention, to be described, using techniques of encryption and cryptographic hashing. These types of threats are addressed for internal adversaries by the “Policy” and Auditing aspects of the present invention.

Threat type 5: Destruction

The fifth kind of threat, the destruction of existing data on the SD, is both a form of “denial of service attack” (as it denies the use of data by destroying it) and a subset of the falsification of data (insofar as it is the limiting case of falsification, where data is falsified into null data). This invention cannot prevent such destruction, but it can detect it.

Threat Type 6: Non-Uniformity

The sixth kind of threat is an extension of the falsification of data on the SD. The present invention addresses this threat through a combination of straightforward prior art methods of data integrity along with the prevention of the falsification of data on the SD by the “Basic Read/Write Cycle” of this invention, as noted in the discussion of Threat Type 4, above.

Prior Art: Security Integrated with the Usage Device

One method in the prior art for increasing the security of data on a Storage Device is the encryption of the data on that Storage Device by the Usage Device. An example of this is the Loop-AES software of Jari Ruusu et. al. (Ruusu 2001ff). In Loop-AES, data on a magnetic disk or similar block-accessed storage device (a subset of the class of DASD, in the terminology used here) attached to a computer is encrypted by the computer. In use, a disk encrypted by Loop-AES is “mounted” for use by the computer upon the successful presentation of an encryption/decryption key. Software in the computer decrypts data read from the disk, and encrypts data written to the disk; cleartext data is never written to the disk.

This approach, while it has many advantages and represents a substantial improvement over non-encrypted disk usage, suffers from several disadvantages inherent in it.

First, the protection of the data is integrated with the Usage Device. This means that an attacker who has compromised the Usage Device has the ability to act arbitrarily with regard to the data: to read it surreptitiously, and also to write false data without detection.

Second, this method emphasizes, without good solution, the issue of key management. The cryptographic key must be stored in such a way as to be associated with the encrypted data. For example, in Loop-AES as implemented, a one-way cryptographic hash of the key is stored with the data. If the key is one that a human operator might be expected to be able to recall and enter, then this approach is subject to “dictionary attacks.” If the key is a sufficiently large true random number, this approach is safe against dictionary attacks but introduces a consequent problem: such a key must be saved somewhere, and this secondary key location itself becomes subject to attack. (Loop-AES suggests the use of a removable external storage device such as a USB “memory stick.”)

Third, this method is not easily generalizable to situations where multiple Computing Environments share a single Storage Device, as each CE must possess the keys for the SD and if a single CE is compromised, all are effectively compromised.

Fourth, this method addresses only threats from external adversaries. The disk protected by Loop-AES or similar encryption technologies is exposed in its entirety to legitimate users. This method therefore provides no protection against malicious or inappropriate or simply mistaken use by otherwise legitimate internal users.

Other prior art of this type, in addition to Loop-AES, includes the Linux operating system “Cryptoloop/CryptoAPI” module (Holzer 2004), the Linux operating system “dm-crypt” package (Saout 2.6), the Microsoft Corporation/Microsoft Windows Operating System encryption API (Microsoft 2007), numerous implementations of similar technologies in various open-source and commercial systems. Issues with and in the construction of solutions of this type have also been discussed in numerous papers in the literature, such as, for an illustrative example, (Fruhwirth 2005).

Prior Art: Security Integrated with the Storage Device

Another method in the prior art for increasing the security of data on a Storage Device is the encryption of the data on that device by a hardware storage controller integrated with the Storage Device. Various manufacturers offer such devices. This method has the advantage of removing attacks on the Usage Device from consideration, but it suffers from the same disadvantages of key management. Additionally, by integrating the protection into the Storage Device, it restricts the use of the security devices to a particular type, and often to a particular brand and model, of Storage Device. Moreover, to the extent that the key management used in such an SD-integrated approach is itself integrated into the Computing Environment (e.g., such that a key may be supplied from the Usage Device or elsewhere in the Computing Environment) it is attackable “in-channel” using any number of conventional system attack methods. Finally, this method protects only against external adversaries, not against legitimate users considered as “internal” adversaries.

An straightforward example of a device of this type implemented primarily in hardware is the “Paranoia2” disk protection device offered by AVAX International (Avax 2006).

Fundamental Software, Incorporated (FSI) produces a z/Architecture compatible computing environment using emulation technologies (“FLEX-ES” (FSI 1992ff)) and z/Architecture compatible devices (in FLEX-ES (FSI 1992ff) and in “FLEXCUB” (FSI 2005a), (FSI 2005b)), also using emulation technologies, which provide, among other features, encryption of emulated mainframe tape devices.

Prior Art: Security Integrated with Communications Paths to Disk and Tape

Slightly less tightly coupled security devices protect data on particular types of Storage Devices by being positioned “inline” in the communications/data path between the UD and the SD. This is the type of prior art which most resembles the present invention.

One prior art device limited in this way is the “Eclipz ESCON Data Encryptor” of Optica Technology, Inc. (Optica 2006a, Optica 2006b) This device exists inline in the communications path (“ESCON channel”) between a z/Architecture mainframe computer (as a UD) and a z/Architecture storage device (SD) such as a DASD or magnetic tape.

The prior art of this type resembles the present invention in some ways, but differs from the present invention in several important ways.

First, it employs methods of cryptographic key management and protection device control which differ from the “Inline Storage Protection Device Key” device and method to be described as a part of this invention. Often these key management methods possess elaborate user interfaces which are themselves susceptible to security compromise.

Second, devices of this type which are commercially available are tied to specific combinations of Storage Devices and communications media. For example, the Optica “Eclipz” device is designed specifically for particular kinds of mainframe computer tape and ESCON mainframe computer channels. These devices are not a part of a generalized framework which allows the construction of a family of related devices which protect storage over the entire range of SDs from Dedicated Access Storage Devices (DedASD, such as central processing unit registers) to Tree Access Storage Devices (TASD, such as Document Object Model (DOM) documents served via Hypertext Transport Protocol (HTTP)) and Relational Access Storage Devices (RelASD, such as relational databases). By comparison with the present invention, they are quite limited in scope.

Third, although examples from the prior art such as the Optica “Eclipz” are designed to handle multiple SDs from a single UD (e.g., multiple tape drives connected to a single mainframe computer), they have not been generalized to handle the operational situation where multiple UDs share a single SD.

Finally, prior art of this type protects only against external adversaries. It does not necessarily protect against internal adversaries, as does the present invention.

Note (for clarification) that products which provide encryption or other protection for emulated storage devices using the general facilities of encrypted networks (for example, Virtual Private Networks, or VPNs) are not examples of inline device protection as described here, but instead are examples of the logically tight coupling of encryption with a storage device although physically distributed over a network. An example of this would be the disaster preparedness and remote backup services offered by Fundamental Software, Inc. using its FLEXCUB emulated devices and VPNs over the public Internet (FSI 2007).

Prior Art: Unnecessary Multiplication of Technological Methods

All methods known to us in the prior art involve a tight coupling of the security mechanism with the storage technology it protects. For example, Loop-AES is intended and designed to protect only disks and media emulating disks. Security devices integrated into a particular Storage Device are tightly linked to that storage device. In order to secure Storage Devices of many different types, many different methods of protection must be employed. As these many methods will each be implemented as if they solution they propose is unique to that class of storage device, they will tend to present different operational procedures and will require an operator or administrator to master many different technologies.

This is a significant disadvantage in security administration, as it presents to the administrator a complex collection of apparently distinct security operational procedures when in fact the conceptual model basic to this invention demonstrates that a single unified approach is possible.

The prior art does include devices which resemble the present invention but which are intended only for the protection of a specific class of SD. More particularly, several commercially available products but which are tightly associated either with particular types of SDs (such as magnetic disks) or with particular types of communications paths (such as mainframe computer z/Architecture “Enterprise System Connection Architecture” (“ESCON”) channels. The Optica “Eclipz” device mentioned in the previous section is such a device.

Prior Art: Remote Storage Devices

One aspect of this invention is that it may be used either with Storage Devices under the control of the operator of this invention (for example, a magnetic disk drive attached to a laptop computer, or the RAM of a “server” computer) or it may be used with Storage Devices provided by others, often remotely. The prior art includes a very commonly implemented example of remote storage devices in the “Network File System” (NFS) system developed by Sun Microsystems (Sun 1989, Sun 2003). NFS provides a hierarchical filesystem to one computer from another, over a network.

The disadvantages of NFS and related methods include its lack of recognition that it constitutes a Storage Device accessible via an Access Protocol (when in fact it is), which hinders the application of security features to it which were designed for other types of Storage Devices, and its integration of security, insofar as it provides security, with the Usage Device (subjecting its security measures to the possibility of attacks on the Usage Device). Thus prior art intended to provide inline protection to tape drives has not been extended to, and it seems therefore nonobvious to extend it to, remotely provided storage devices of distinctly different types such as NFS TASD.

As noted earlier, prior art in which a Storage Device is logically local but which is made to appear remote by access over a separate network such as a VPN over the public Internet is an instance of a local, not a remote, Storage Device. See the remote encrypted device services described in (FSI 2007) for an example of this.

### OBJECTS AND ADVANTAGES

The object of this invention is to provide data securely from and to supply data securely to a Storage Device from one or more Usage Devices in one or more Computing Environments in such a way that
(a) data stored on the device may not be read by an unauthorized attacker even in the event of the theft of the Storage Device by the unauthorized attacker, and
(b) an unauthorized attacker may not introduce false data into the Storage Device, and
(c) an authorized and otherwise legitimate user of the data may be limited in action by policy set by the owner of the data, and
(d) authorized and otherwise legitimate use of the data may be recorded by audits.

Additional objects are to provide this security in an easily used and administered way and to provide a single security technology over the entire range of Storage Devices, including many types of Storage Devices presently not commonly thought of as Storage Devices.

Advantages of this invention over the prior art include:

(a) the decoupling of the security technology from the Storage Device itself, allowing the use of this security technology with Storage Devices of many types and models,
(b) the decoupling of the security technology from Storage Devices limited to some particular class (as described in the Terminology earlier), allowing the use of this security technology with Storage Devices of many classes, including classes of Storage Devices not commonly realized to be Storage Devices,
(c) through the use of this single security technology over the full range of classes of Storage Devices, the simplification of the issues of security administration of heretofore apparently disparate types of devices even within a single class of device,
(d) the separation of and forced removeal of the device which provides the data security itself from the device which enables and disables it, eliminating many important problems in the area of cryptographic key management,
(e) the integration of encryption-oriented security technology which protects against external adversaries at the same point and in the same device which provides policy and audit protection against otherwise legitimate internal users of the data,
(f) in at least one operational scenario, multiple protected Storage Devices each of which maintains effectively identical data yet is protected independently from the others, in such a way that the loss or compromise of one Storage Device does not compromise the others.

### SUMMARY

The invention consists of one or more pairs of two kinds of devices: an “Inline Storage Protection Device” (“ISPD”) and an associated “Inline Storage Protection Device Key” (“ISPDK”). This pair or these pairs of devices are constructed so as to operate together with a Storage Device which may be local to them or remote from them. The Storage Device may be under the control of the operator of the ISPD, or may be a remote device not necessarily under this operator's control. The operation of an ISPD/ISPDK/SD is such that:

(1) The ISPDK protects the ISPD from unauthorized use. In a manner forced by the ISPD, the ISPDK must be physically removed from the ISPD after its use with the ISPD. The ISPDK may be a standalone device, or it may be connected to a service provider which provides its necessary operating information as a service.

(2) Through a Basic Read-Write Cycle, described in the Detailed Descriptions below, the ISPD secures data read from and written to the Storage Device by means both of encryption and cryptographic hashes.

(3) The ISPD may coordinate the contents of its SD with an external Coordinating Storage facility. When multiple ISPDs coordinate against the same external Coordinating Storage facility, they effectively maintain each SD as logically identical to every other SD so coordinating.

(4) The ISPD at all times enforces programmatically defined data use policy (including the null policy) and data auditing (including null auditing) on the data in its SD. The programmatic definitions of this policy and auditing may be defined permanently for an ISPD or may be changed over time from a remote Policy Control facility.

### DRAWINGS

### Figures

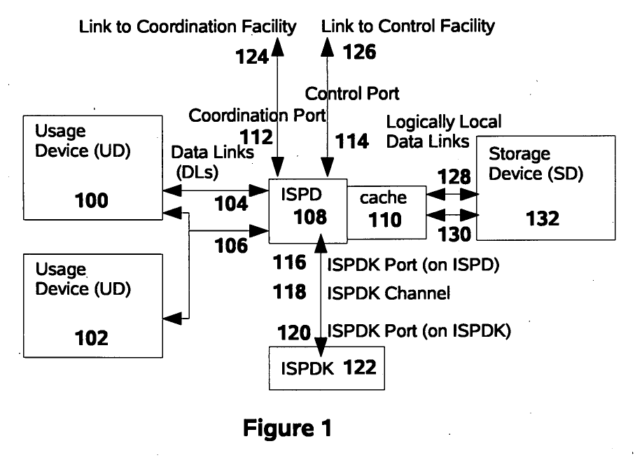

FIG. 1 is an ISPD and ISPDK in Local-SD, Independent Mode Operation

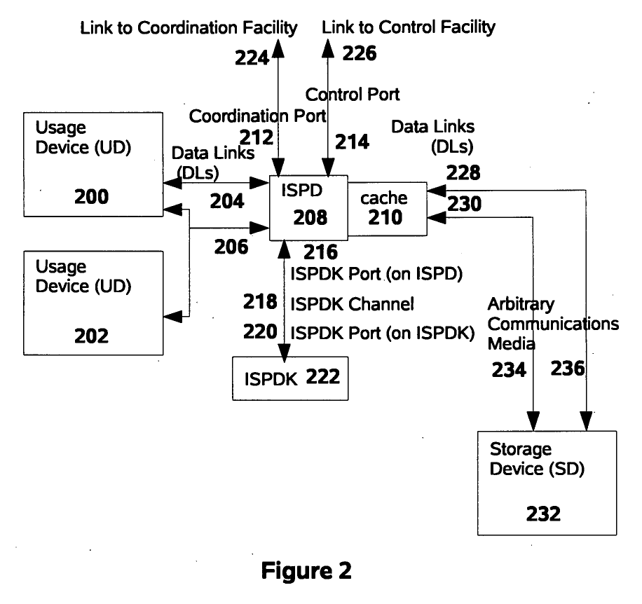

FIG. 2 is an ISPD and ISPDK in Remote-SD, Independent Mode Operation

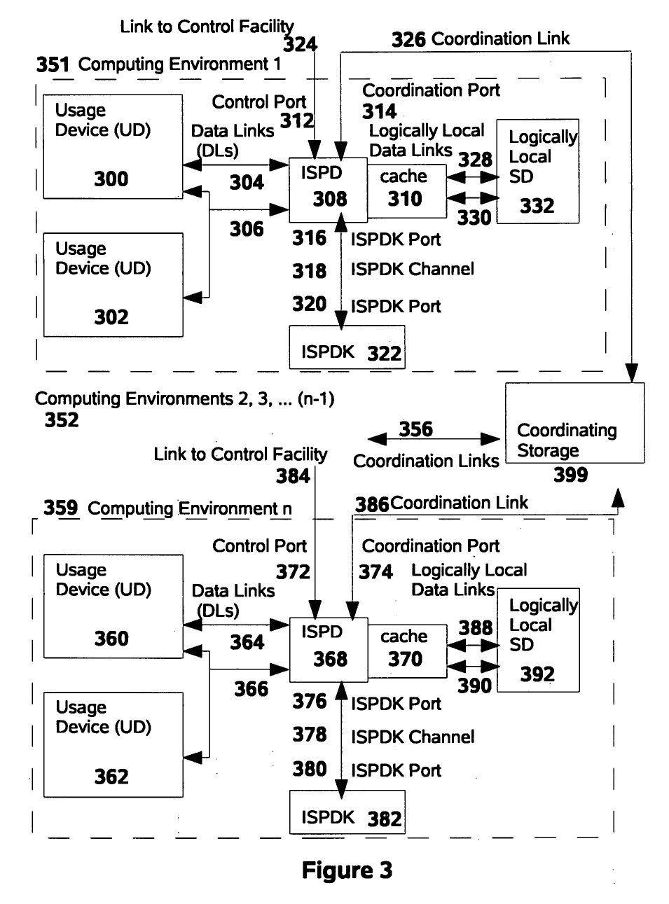

FIG. 3 represents Multiple Computing Environments (CE) in with ISPDs and ISPDKs in Local-SD, Coordinated Mode Operation

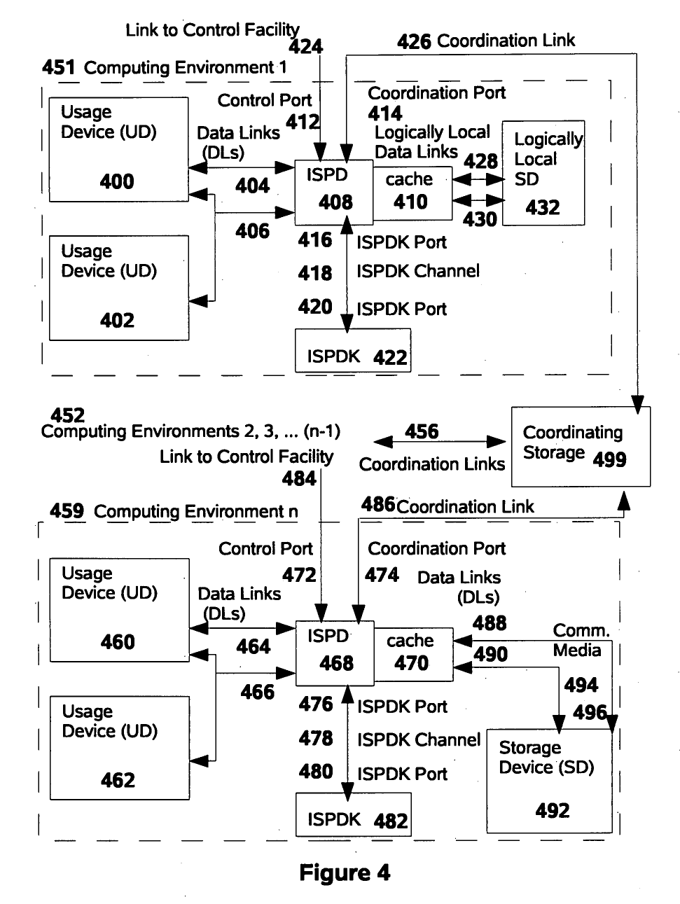

FIG. 4 represents Multiple Computing Environments (CE) with ISPDs and ISPDKs in Mixed Local-SD/Remote-SD, Coordinated Mode Operation

FIG. 5 is the Basic Usage-Storage Model (BM)

FIG. 6 is a Composite Storage Device

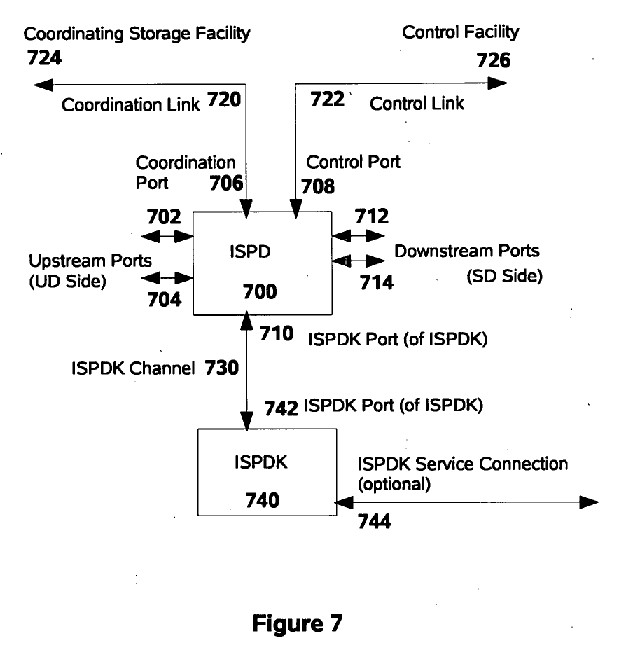

FIG. 7 is an ISPD and an ISPDK (Detail)

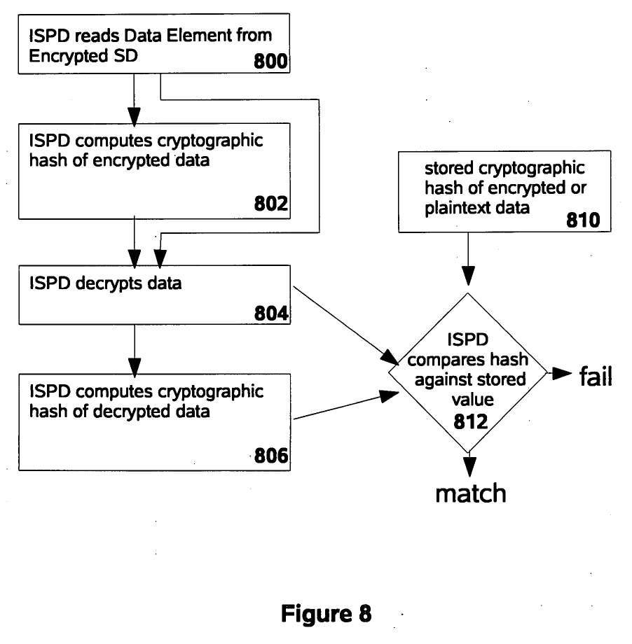

FIG. 8 is a Flowchart of the Basic Read Cycle

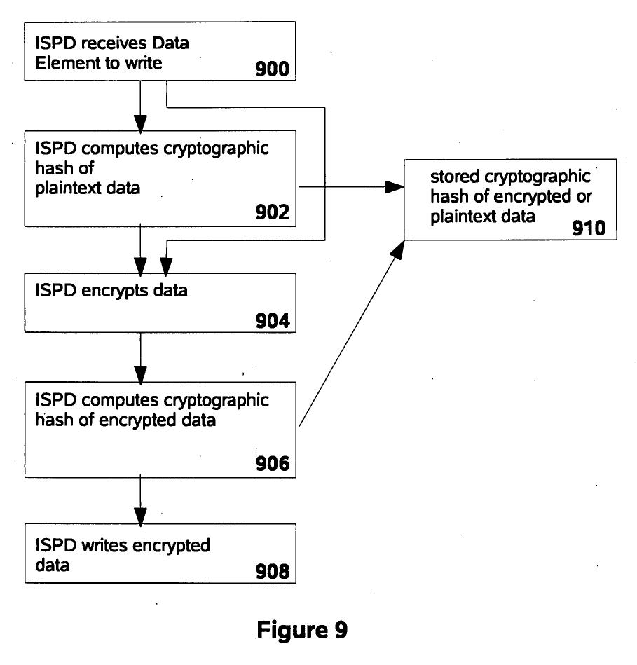

FIG. 9 is a Flowchart of the Basic Write Cycle for New Data Elements

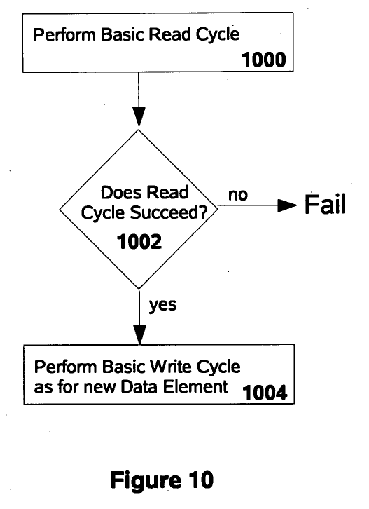

FIG. 10 is a Flowchart of the Basic Write Cycle for Modified Data Elements

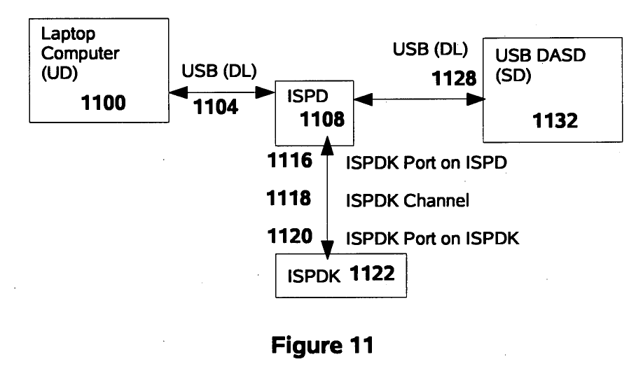

FIG. 11 is A Preferred Embodiment

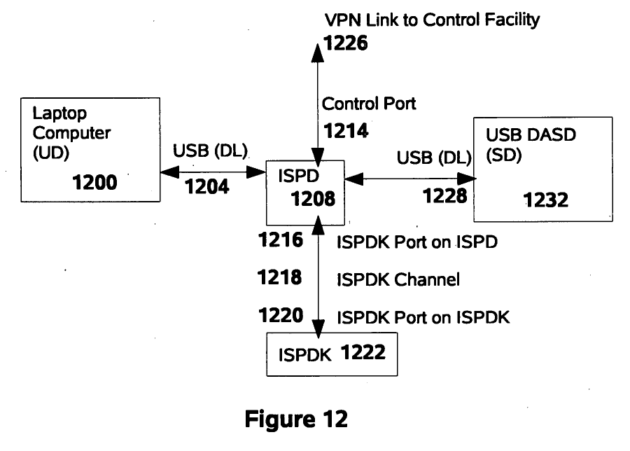

FIG. 12 is An Alternative Embodiment

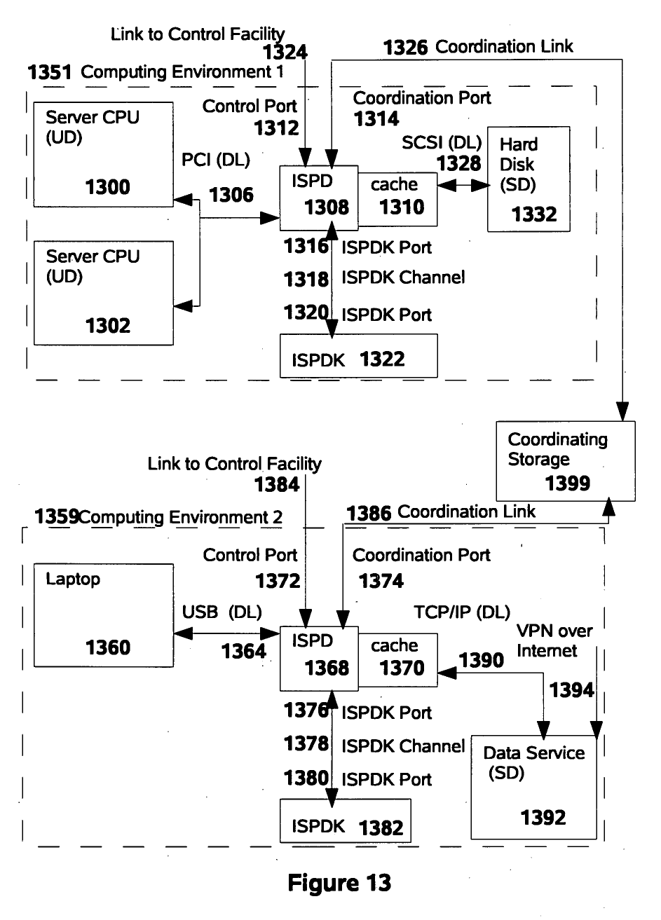

FIG. 13 is An Alternative Embodiment

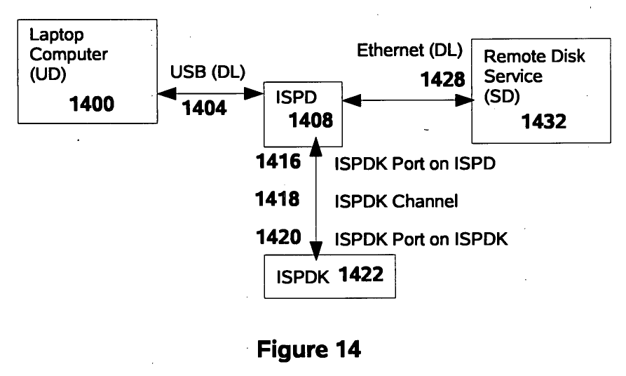

FIG. 14 is An Alternative Embodiment

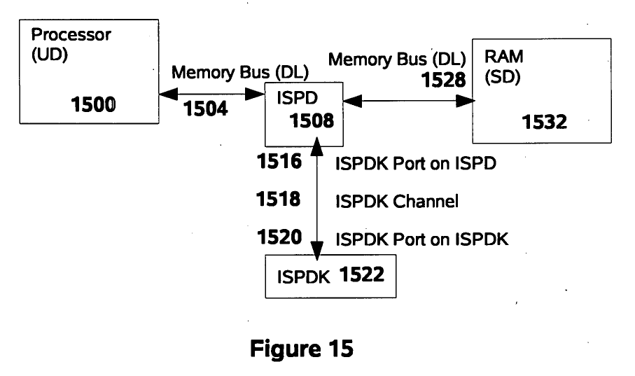

FIG. 15 is An Alternative Embodiment

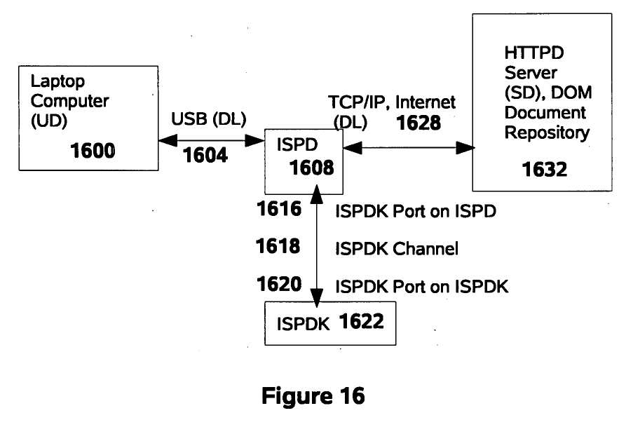

FIG. 16 is An Alternative Embodiment

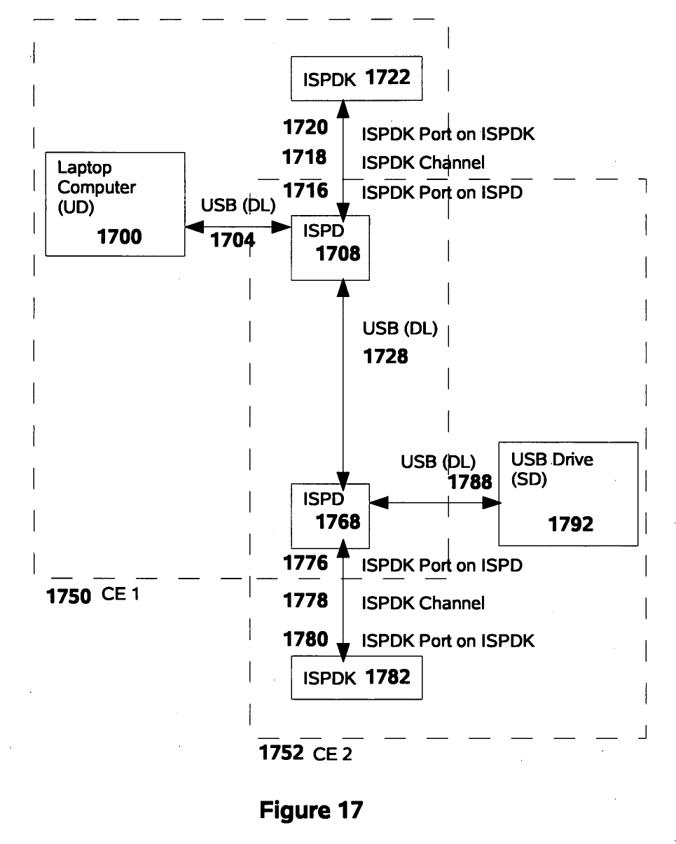

FIG. 17 is An Alternative Embodiment

### DRAWINGS

### Reference Numerals

FIG. 1. ISPD and ISPDK in Local-SD, Independent Mode Operation:
100 A Usage Device
102 A Usage Device
104 A Data Link (DL) between a Usage Device (UD) 100 and ISPD 108
106 A Complex Data Link (DL) between a Usage Device (UD) 102 and ISPD 108
108 An Inline Storage Protection Device (ISPD)
110 A Cache for ISPD 108
112 A Coordination Port on ISPD 108
114 A Control Port on ISPD 108
116 An ISPDK Port on ISPD 108
118 An ISPDK Channel for ISPD 108 and ISPDK 122
120 An ISPDK Port on ISPDK 122
122 An Inline Storage Protection Device Key (ISPDK)
124 A Link to an External Coordination Facility
126 A Link to an External Control Facility
128 A Data Link (DL) between ISPD 108/Cache 110 and a Storage Device 132
130 Another Data Link (DL) between ISPD 108/Cache 110 and a Storage Device 132
132 A Storage Device (SD)

FIG. 2. ISPD and ISPDK in Remote-SD, Independent Mode Operation:
200 A Usage Device
202 A Usage Device
204 A Data Link (DL) between a Usage Device (UD) 200 and ISPD 208
206 A Complex Data Link (DL) between a Usage Devices (UD) 200 and 202 and ISPD 208
208 An Inline Storage Protection Device (ISPD)
210 A Cache for ISPD 208
212 A Coordination Port for ISPD 208
214 A Control Port for ISPD 208
216 An ISPDK Port on ISPD 208
218 An ISPDK Channel for ISPD 208 and ISPDK 222
220 An ISPDK Port on ISPDK 222
222 An Inline Storage Protection Device Key (ISPDK)
224 A Link to an External Coordination Facility
226 A Link to an External Control Facility
228 A Data Link (DL) between ISPD 208/Cache 210 and a Storage Device 232
230 Another Data Link (DL) between ISPD 208/Cache 210 and a Storage Device 232
232 A Storage Device (SD)
234 An Arbitrary Communications Medium Over Which Runs Data Link (DL) 228
236 An Arbitrary Communications Medium Over Which Runs Data Link (DL) 230

FIG. 3. Multiple Computing Environments (CE) with ISPDs and ISPDKs in Local-SD,

Coordinated Mode Operation:
300 A Usage Device
302 A Usage Device
304 A Data Link (DL) between a Usage Devices (UD) 300 and ISPD 308
306 A Complex Data Link (DL) between Usage Devices (UDs) 300 and 302 and ISPD 308
308 An Inline Storage Protection Device (ISPD)
310 A Cache for ISPD 308
312 A Control Port for ISPD 308
314 A Coordination Port for ISPD 308
316 An ISPDK Port on ISPD 308
318 An ISPDK Channel for ISPD 308 and ISPDK 322
320 An ISPDK Port on ISPDK 322
322 An Inline Storage Protection Device Key (ISPDK)
324 A Link to an External Control Facility
326 A Link to External Coordinating Storage Facility 399
328 A Data Link (DL) between ISPD 308/Cache 310 and a Storage Device 332
330 Another Data Link (DL) between ISPD 308/Cache 310 and a Storage Device 332
332 A Storage Device, Logically Local to ISPD 308
351 Computing Environment 1
352 [An indication that there exist] Computing Environments 2, 3, 4, . . . (n−1)
356 [An indication that there exist] Coordination Links between the ISPDs of the Computing
Environments 2, 3, . . . (n−1) of 352 and the Coordinating Storage Facility 399
359 Computing Environment n
360 A Usage Device
362 A Usage Device
364 A Data Link (DL) between a Usage Device (UD) 360 and ISPD 368
366 A Complex Data Link (DL) between Usage Devices (UDs) 360 and 362 and ISPD 368
368 An Inline Storage Protection Device (ISPD)
370 A Cache for ISPD 368
372 A Control Port for ISPD 368
374 A Coordination Port for ISPD 368
376 An ISPDK Port on ISPD 368
378 An ISPDK Channel for ISPD 368 and ISPDK 382
380 An ISPDK Port on ISPDK 382
382 An Inline Storage Protection Device Key (ISPDK)
384 A Link to an External Control Facility
386 A Link to External Coordinating Storage Facility 399
388 A Data Link (DL) between ISPD 368/Cache 370 and a Storage Device 392
390 Another Data Link (DL) between ISPD 368/Cache 370 and a Storage Device 392
392 A Storage Device, Logically Local to ISPD 368
399 Coordinating Storage Facility Shared By All Computing Environments

FIG. 4. Multiple Computing Environments (CE) with ISPDs and ISPDKs in Mixed Local-SD/Remote-SD, Coordinated Mode Operation
400 A Usage Device
402 A Usage Device
404 A Data Link (DL) between a Usage Device (UD) 400 and ISPD 408
406 A Complex Data Link (DL) between Usage Devices (UDs) 400 and 402 and ISPD 408
408 An Inline Storage Protection Device (ISPD)
410 A Cache for ISPD 408
412 A Control Port for ISPD 408
414 A Coordination Port for ISPD 408
416 An ISPDK Port on ISPD 408
418 An ISPDK Channel for ISPD 408 and ISPDK 422
420 An ISPDK Port on ISPDK 422
422 An Inline Storage Protection Device Key (ISPDK)
424 A Control Link to an External Control Facility
426 A Coordination Link to External Coordinating Storage Facility 499
428 A Data Link (DL) between ISPD 408/Cache 410 and a Storage Device 432
430 Another Data Link (DL) between ISPD 408/Cache 410 and a Storage Device 432
432 A Storage Device, Logically Local to ISPD 408
451 Computing Environment 1
452 [An indication that there exist] Computing Environments 2, 3, 4, . . . (n−1)
456 [An indication that there exist] Coordination Links between the ISPDs of the Computing Environments 2, 3, . . . (n−1) of 452 and the Coordinating Storage Facility 499
459 Computing Environment n
460 A Usage Device
462 A Usage Device
464 A Data Link (DL) between a Usage Device (UD) 460 and ISPD 468
466 A Complex Data Link (DL) between Usage Devices (UDs) 460 and 462 and ISPD 468
468 An Inline Storage Protection Device (ISPD)
470 A Cache for ISPD 468
472 A Control Port for ISPD 468
474 A Coordination Port for ISPD 468
476 An ISPDK Port for ISPD 468
478 An ISPDK Channel for ISPD 468 and ISPDK 482
480 An ISPDK Port for ISPDK 482
482 An Inline Storage Protection Device Key (ISPDK)
484 A Link to an External Control Facility
486 A Link to External Coordination Storage Facility 499
488 A Data Link (DL) between ISPD 468/Cache 470 and a Storage Device 492
490 Another Data Link (DL) between ISPD 468/Cache 470 and a Storage Device 492
492 A Storage Device, Logically Local to ISPD 468
494 An Arbitrary Communications Medium Over Which Runs Data Link (DL) 490
496 An Arbitrary Communications Medium Over Which Runs Data Link (DL) 488
499 Coordinating Storage Facility Shared By All Computing Environments

FIG. 5. The Basic Model:
500 A Usage Device (UD)
502 A Data Link (DL)
504 A Storage Device (SD)

FIG. 6. A Composite SD:
600 A Usage Device (UD)
602 A Data Link (DL)
604 A Storage Device (SD)
606 A Usage Device (UD) within Composite Storage Device (SD) 604
608 Data Links (DLs) within Composite Storage Device (SD) 604
610 A Storage Device (SD) within Composite Storage Device (SD) 604
612 Another Storage Device (SD) within Composite Storage Device (SD) 604
614 Another Storage. Device (SD) within Composite Storage Device (SD) 604

FIG. 7. ISPD and ISPDK (Detail):
700 An Inline Storage Protection Device (ISPD)
702 An Upstream (UD-Side) ISPD Port (of ISPD 700).
704 Another Upstream (UD-Side) ISPD Port (of ISPD 700)
706 The Coordination Port of ISPD 700
708 The Control Port of ISPD 700
710 The Inline Storage Protection Device Key (ISPDK) Port of ISPD 700
712 A Downstream (SD-Side) ISPD Port (of ISPD 700)
714 Another Downstream (SD-Side). ISPD Port (of ISPD 700)
720 A Coordination Link between ISPD 700 and Coordinating Storage Facility 724
722 A Control Link between ISPD 700 and Control Facility 726
724 An External Coordinating Storage Facility
726 An External Control Facility
730 An ISPDK Channel
740 An Inline Storage Protection Device Key (ISPDK)
742 The ISPDK Port (of ISPDK 740)
744 An ISPDK Service Connection to ISPDK 740

FIG. 8. The Basic Read Cycle
800 Flowchart Step—Basic Read Cycle, Step 1, Read
802 Flowchart Step—Basic Read Cycle, Step 2, Compute Hash
804 Flowchart Step—Basic Read Cycle, Step 3, Decrypt Data
806 Flowchart Step—Basic Read Cycle, Step 4, Compute Hash of Decrypted Data
810 Flowchart Step—Basic Read Cycle, Obtain Stored Hash Data
812 Flowchart Step—Basic Read Cycle, Match/Fail Decision

FIG. 9. The Basic Write Cycle (New Data Element)
900 Flowchart Step, Basic Write Cycle, Step 1, Receipt
902 Flowchart Step, Basic Write Cycle, Step 2, Compute Hash
904 Flowchart Step, Basic Write Cycle, Step 3, Data Encryption
906 Flowchart Step, Basic Write Cycle, Step 4, Compute Hash of Encrypted Data
908 Flowchart Step, Basic Write Cycle, Step 5, Write Encrypted Data
910 Flowchart Step, Basic Write Cycle, Store Hash Data

FIG. 10. The Basic Write Cycle (Modified Data Element)
1000 Flowchart Step, Basic Write Cycle, Step 1, Do Basic Read Cycle
1002 Flowchart Step, Basic Write Cycle, Step 2, Success/Failure Decision
1004 Flowchart Step, Basic Write Cycle, Step 3, Perform Basic Write Cycle

FIG. 11. A Preferred Embodiment
1100 A Laptop Computer (UD)
1104 A USB Link (DL) between Laptop Computer 1100 and ISPD 1108
1108 An ISPD
1116 An ISPDK Port on ISPD 1108
1118 An ISPDK Channel
1120 An ISPDK Port on ISPDK 1122
1122 An ISPDK
1128 A USB Link (DL) between ISPD 1108 and USB DASD (SD) 1132
1132 A USB DASD (SD)

FIG. 12. An Alternative Embodiment
1200 A Laptop Computer (UD)
1204 A USB Link (DL) between Laptop Computer 1200 and ISPD 1208
1208 An ISPD
1214 A Control Port on ISPD 1208
1216 An ISPDK Port on ISPD 1208
1218 An ISPDK Channel
1220 An ISPDK Port on ISPDK 1222
1222 An ISPDK
1226 A Link to an External Control Facility over a VPN over an Arbitrary Network
1228 A USB Link (DL) between ISPD 1208 and USB DASD (SD) 1232
1232 A USB DASD (SD)

FIG. 13: An Alternative Embodiment
1300 A Server CPU (UD)
1302 A Server CPU (UD)
1306 A PCI Bus (DL) between Servers (UDs) 400 and 402 and ISPD 408
1308 An Inline Storage Protection Device (ISPD)
1310 A Cache for ISPD 1308
1312 A Control Port for ISPD 1308
1314 A Coordination Port for ISPD 1308
1316 An ISPDK Port on ISPD 1308
1318 An ISPDK Channel for ISPD 1308 and ISPDK 1322
1320 An ISPDK Port on ISPDK 1322
1322 An Inline Storage Protection Device Key (ISPDK)
1324 A Control Link to an External Control Facility
1326 A Coordination Link to External Coordinating Storage Facility 1399
1328 A SCSI Bus (DL) between ISPD 1308/Cache 1310 and Hard Disk (SD) 1332
1332 A Hard Disk Drive (SD), Logically Local to ISPD 1308
1351 Computing Environment 1
1359 Computing Environment 2
1360 A Laptop Computer (UD)
1364 A USB (DL) between Laptop Computer (UD) 1360 and ISPD 1368
1368 An Inline Storage Protection Device (ISPD)
1370 A Cache for ISPD 1368
1372 A Control Port for ISPD 1368
1374 A Coordination Port for ISPD 1368
1376 An ISPDK Port for ISPD 1368
1378 An ISPDK Channel for ISPD 1368 and ISPDK 1382
1380 An ISPDK Port for ISPDK 1382
1382 An Inline Storage Protection Device Key (ISPDK)
1384 A Link to an External Control Facility
1386 A Link to External Coordination Storage Facility 1399
1390 TCP/IP (DL) between ISPD 1368/Cache 1370 and Data Service (SD) 1392
1392 A Data Service, Logically Remote from ISPD 1368
1394 An Arbitrary Communications Medium Over Which Runs Data Link (DL) 1390
1399 Coordinating Storage Facility Shared By All Computing Environments

FIG. 14. An Alternative Embodiment
1400 A Laptop Computer (UD)
1404 A USB Link (DL) between Laptop Computer 1400 and ISPD 1408
1408 An ISPD
1416 An ISPDK Port on ISPD 1408
1418 An ISPDK Channel
1420 An ISPDK Port on ISPDK 1422
1422 An ISPDK
1428 An Ethernet Link (DL) between ISPD 1408 and Network Attachable Disk (SD) 1432
1432 A Remote Disk Service (SD)

FIG. 15. An Alternative Embodiment
1500 A Computer Processor Unit (UD)
1504 A Memory Bus (DL) between Processor 1500 and ISPD 1508
1508 An ISPD
1516 An ISPDK Port on ISPD 1508
1518 An ISPDK Channel
1520 An ISPDK Port on ISPDK 1522
1522 An ISPDK
1528 A Memory Bus (DL) between ISPD 1508 and Random Access Memory (SD) 1532
1532 Random Access Memory (RAM) (SD)

FIG. 16. An Alternative Embodiment
1600 A Laptop Computer (UD)
1604 A USB Link (DL) between Laptop 1600 and ISPD 1608
1608 An ISPD
1616 An ISPDK Port on ISPD 1608
1618 An ISPDK Channel
1620 An ISPDK Port on ISPDK 1622
1622 An ISPDK
1628 TCP/IP over a VPN over the Public Internet between ISPD 1608 and HTTPD/DOM Server (SD) 1632
1632 An HTTPD Server serving a Repository of DOM Structured Documents (SD)

FIG. 17. An Alternative Embodiment
1700 A Laptop Computer (UD)
1704 A USB Link (DL) between Laptop 1700 and ISPD 1708
1708 An ISPD
1716 An ISPDK Port on ISPD 1708
1718 An ISPDK Channel
1720 An ISPDK Port on ISPDK 1722
1722 An ISPDK
1728 A USB Link (DL) Between ISPD 1708 and ISPD 1768
1750 Computing Environment (CE) 1
1752 Computing Environment (CE) 2
1768 Another ISPD
1776 An ISPDK Port on ISPD 1768
1778 An ISPDK Channel
1780 An ISPDK Port on ISPDK 1782
1782 An ISPDK
1788 A USB Link (DL) Between ISPD 1768 and USB Drive (SD) 1792
1792 A USB Drive (SD)

### DETAILED DESCRIPTION—

The invention consists of one or more pairs of two kinds of devices, an “Inline Storage Protection Device” (“ISPD”) and an “Inline Storage Protection Device Key” (ISPDK). FIG. 7 illustrates a pair of such devices. For each ISPD/ISPDK pair, there must also be a Storage Device (SD) intended to operate in conjunction with the ISPD. Optionally there may also be an external “Control” facility used for updating the programmatic definitions of the usage policy and auditing implemented by the ISPD. (An ISPD enforces policy and auditing at all times. The optional link to an external Control facility provides only the additional ability to alter the programmatic definitions of the policy and auditing.) Optionally there may also be an external “Coordinating Storage” facility used by multiple ISPDs to maintain the contents of their SDs in a mutually effectively identical state.

Each ISPD may be designed and/or configured to operate in a mode whereby its SD is intended itself to be operated under the control of the user of the ISPD (so-called “Local-SD” operation) or not under the control of the user of the ISPD (so-called “Remote-SD” operation). In each case, the logic of the operation is identical but the security implications for the implementation differ; it is thus useful in practice to maintain this distinction. FIG. 1 illustrates Local-SD Operation, and FIG. 2 illustrates Remote-SD Operation

Further, an ISPD may operate in such a way that its SD is “Independent” of all other SDs. The ISPD/SD unit, whether “Local-SD” or “Remote-SD” thus forms an independent or self-sufficient unit and the contents of the SD depend only on its initial state and on input via the ISPD. FIG. 1 illustrates Independent Mode Operation (in Local-SD Mode) and FIG. 2 illustrates Independent Mode Operation (in Remote-SD Mode).

Alternatively, and ISPD may operate in such a way that its SD is “Coordinated” with an external “Coordinating Storage” and maintains an effective image of the contents of that storage (and conversely the Coordinated Storage is maintained in an image of the SD). This may be done by implementing solutions well known in the art to the problems of the concurrent use of and attempted simultaneous update of data. These issues are discussed in the literature. See (Date 1985) for a discussion of this in the context of database systems, or (Collins-Sussman 2002) for a discussion of this in the context of revision control systems, or any good introductory computer science textbook for an abstract discussion. This “Coordinated” operation itself may be done in either Local-SD or in Remote-SD operation; the “Coordinating Storage” is distinct from a “Remote SD.” If multiple ISPD/SDs coordinate against the same Coordinating Storage, they effectively each maintain a consistent copy of each other's data and the data of the Coordinating Storage. This occurs even though the encryption of each SD is unique to it and uniquely associated with its ISPD. In this way, multiple SDs may be maintained consistently in such a way that the loss of or compromise of any individual copy does not necessarily result in the compromise of all copies. FIG. 3 illustrates Coordinated Mode Operation (with all ISPDs also in Local-SD Mode Operation).

The combination of Local and Remote SD connections for an ISPD and Independent and Coordinated operation give, combinatorially, four operational possibilities for a given ISPD. Moreover, in Coordinated operation each participating ISPD may itself be operating in either Local-SD or Remote-SD mode; there is no requirement that all ISPDs in Coordinated Operation operate in the same Local/Remote SD mode. FIG. 4 illustrates Coordinated Mode Operation with a mixture of Local-SD and Remote-SD Mode Operation for the individual ISPD/SD sets.

The components of the invention will be described individually first, and then the modes of operation will be described.

Description of an ISPD: Its Connections

An “Inline Storage Protection Device” (“ISPD”) is a device which presents the following connections:

(1) One or more data/control ports, named the “Upstream Port” (“UP”) or if plural the “Upstream Ports”. (“UPs”), which operate(s) using any appropriate Data Link (DL) protocol and its associated hardware. (Note that, as noted earlier, the term “Data Link” here indicates a generalized data/communications link, as described earlier, which itself may include multiple “protocol layers” as generally understood in the art. It does not refer to the similar term for a particular protocol layer in the International Organization for Standardization's (ISO's) Open Systems Interconnection (OSI) Basic Reference Model (the ISO OSI model.)) Examples of such DL protocols and hardware include USB, Ethernet, PCI busses, other system busses, TCP/IP networks, wireless networks, and so forth. As implemented an ISPD must implement at least one such protocol, but may implement more than one as desired. Upstream Ports are illustrated as items 702 and 704 in FIG. 7.

(2) One or more data/control ports, named the “Downstream Port” (“DP”) or if plural the “Downstream Ports” (“DPs”) which operate(s) using any appropriate Data Link (DL) protocol and its associated hardware. These protocols and their hardware may be the same as or different than those of the Upstream Port(s). For example, an ISPD might have a Downstream Port which used the USB DL protocol to communicate with an SD and have an Upstream Port which used the Ethernet DL protocol to communicate with a UD. Downstream Ports are illustrated as items 712 and 714 in FIG. 7.

(3) A single control port, named the “Inline Storage Protection Device Key Port” (“ISPDK Port,” or simply “KP”) for communication with the Inline Storage Protection Device Key (“ISPDK”) required by the invention. Communications through this port may take place using nonstandard and/or obfuscated protocols, in addition to being encrypted. The hardware for this port may be wired or wireless. The communications path between an ISPD and its ISPDK is called an “ISPDK Channel.” An ISPDK Port on an ISPD is illustrated as item 710 in FIG. 7.

(4) Optionally, a Control Port used to connect to an external Control facility. Through this Control Port an encrypted private network connection is established to a logically external Control facility. A Control Port is illustrated as item 708 in FIG. 7. The Control Port is logically distinct from the Coordination Port of the ISPD, but in practice may be implemented either as a separate physical connection or as physically integrated with the Coordination Port.

(5) Optionally, a Coordination Port used in Coordinated Mode Operation by the ISPD to maintain the contents of its SD in coordination with an external Coordinating Storage facility. Through this Coordinating Port an encrypted private network connection is established to a logically external Coordinating Storage facility. A Coordination Port is illustrated as item 706 in FIG. 7. The Coordination Port is logically distinct from the Control Port of the ISPD, but in practice may be implemented either as a separate physical connection or as physically integrated with the Control Port.

(6) Optionally, a two-position switch, the positions of which select whether, upon enabling, the ISPD is to function in a read-only or read-write operation. This switch is not illustrated on FIG. 7.

(7) Optionally for any Upstream Port, a similar switch. These switches are not illustrated on FIG. 7.

(8) Optionally, a connection for external power. This power connection is not illustrated on FIG. 7.

Optionally, an ISPD may also have externally visible status indicators, such as digital alphanumeric displays (for example, for displaying the number of times it has been enabled) and digital symbolic displays (for example, light-emitting diodes to indicate that the ISPD has been enabled and that the ISPDK must be removed, or to indicate that the ISPD is in read-only operation).

FIG. 7 shows an ISPD and its associated ISPDK diagrammatically. In this figure, 700 represents the ISPD itself. 702 and 704 are illustrative of the one or more Upstream Ports (which connect to Usage Devices) that an ISPD might have. 712 and 714 are illustrative of the one or more Downstream Ports that an ISPD might have. 710 illustrates the required ISPDK Port. 706 illustrates the optional Coordination Port. 708 illustrates the optional Control Port. This figure does not illustrate the optional external features of an ISPD; in particular, it does not show the optional read/write state switch or switches, nor the optional external power connector.

Description of an ISPD: Internal Capabilities

The ISPD must contain internally the following:

(1) Computational capacity and appropriate programming to implement the encryption of the associated SD, using cryptographic techniques common in the art.

(2) Computational capacity, appropriate hardware if necessary, and appropriate programming to implement all protocol levels of the Data Link(s) (DLs) and the Access Protocol(s) (APs) of the SD.

(3) Computational capacity, appropriate hardware if necessary, and appropriate programming to implement all protocols over its Control Port (if present) and its Coordination Port (if present).

(4) Computational capacity and appropriate programming to implement usage policy and auditing of data on the SD.

(5) Storage capacity sufficient to maintain such local auditing records as required.

(6) Storage capacity sufficient to contain its own enabling Key or Keys as used with the ISPDK.

(7) Storage capacity sufficient to contain one or more cryptographic keys used to encrypt the Data Elements in the SD.

(8) Storage capacity sufficient to contain cryptographic hashes of all plaintext and/or ciphertext Data Elements in or to be in the SD.

The ISPD may, additionally, contain other components, including:

(1) A real-time clock.

(2) A hardware random number generator (“RNG”) suitable for cryptographic applications. If an ISPD does not contain an RNG, then it relies for the random numbers required in its cryptographic functions on an external RNG.

(3) Other computational capacity as appropriate, including capacity for internal monitoring and diagnostic service.

Description of an ISPD: Initialization

At time of manufacture, an ISPD is initialized with the following:

(1) Its programming, in non-volatile internal storage.

(2) Seed or seeds for its random number generator, if one is present, as appropriate.

(3) Its real-time clock, if one is present.

(4) Its enabling Key or Keys to be used with its ISPDK.

(5) Initial programmatic definitions of the policy to be enforced on the use of data.

(6) Initial programmatic definitions of the auditing to be conducted on the use of data.

Discussion: If the programmatic definitions of policy and auditing cannot be updated by an external Control facility because the ISPD has been constructed without a Control Port, then these initial definitions are also the permanent definitions for the ISPD. At the time of manufacture, an ISPD also may be initialized with the following:

(1) Encryption key values for encrypting Data Elements.

Discussion: The encryption key values may either be fixed at initialization from its internal RNG or from an external source by the ISPD manufacturer, or generated as needed from the ISPD's RNG. The advantage of values fixed at time of manufacture is that the ISPD may be reconstructed by the manufacturer if it is damaged. The advantage of values generated as needed is that these values remain secure even if the manufacturer's database of values should be compromised.

Description of an ISPD: Potential Deployment Locations in a CE

Regardless of mode of operation, ISPD deployment within a Computing Environment (CE) is governed by these rules:

(1) An ISPD may be placed in a Computing Environment at any point where the CE's architecture would permit a Data Link between an SD and a UD, including positions within a composite SD.

(2) If any cache is present, in order to participate in the protection offered by the ISPD it must be on the SD side of the ISPD. If this is not done then cached data may exist beyond the control of the ISPD.

(3) If there are multiple DLs to the SD, all of them must be connected to a single ISPD. Since the purpose of the ISPD is to provide secure access to the SD, there cannot be other DLs to the SD bypassing it. Two or more ISPDs to a single SD cannot be used because a security failure on one of them might remain unknown to the other, resulting in a situation of presumed but false security.

The ISPD completely severs the DL or DLs as it or they might exist or might have existed without the ISPD. Its Upstream Port or Ports connect(s) via a DL to a UD or UDs as appropriate. Its Downstream Port or Ports connect(s) via a DL or DLs to the SD.

The type of DL need not be the same on the Upstream and Downstream side. For example, the Upstream DL may be a PCI bus and the Downstream DL may be an Ethernet network. Moreover, since the ISPD effectively presents the SD to the Upstream side, the type of the Downstream link need not be known to or supported by the Upstream side of the Computing Environment. This ability to function as a potentially general purpose SD protocol adapter is a side effect of the flexibility of the invention, not one of its purposes.

Note that the DLs are different from the Coordination Links. The Coordination Links, set up by the ISPD through its Coordination Port, are encrypted private data/communications links the endpoints of which are buried within the ISPD (at one end) and a secure remote Coordinating Storage facility (at the other end). The Coordination Link does not directly connect to the SD; it connects to the ISPD. This is shown in isolation in FIG. 7, and for various operational configurations in FIGS. 1, 2, 3, and 4.

The DLs are also different from Control Links and (perhaps obviously) from ISPDK Channels.

A Computing Environment may deploy arbitrarily many ISPDs throughout its topology, subject to the single ISPD per SD limit described above.

However, multiple ISPDs may be deployed serially on a single DL. This does not violate the rule requiring only one ISPD to an SD, because only one of the ISPDs so deployed does access the SD; subsequent ISPDs on the DL access the preceding ISPD and re-present the (now virtualized) SD presented by that ISPD. This arrangement may or may not provide additional technical (e.g., cryptographic) advantages, but it may well provide additional operational advantages when control of an SD by multiple parties is desirable (as each ISPD in such a serial deployment along a single DL would have to be enabled for the SD to be accessible, and the enabling of each ISPD could be in the control of a different party).

Description of the ISPDK

Every ISPD requires an Inline Storage Protection Device Key (“ISPDK.”) Best practice would suggest a one-to-one relationship between them so that the ISPDK for each ISPD is unique. One-to-many and many-to-one relationships between ISPDKs and ISPDs (i.e., using a single ISPDK for multiple ISPDs, or having multiple ISPDKs for, a single ISPD) are not forbidden, but represent potentially dangerous operating practices and such practices should be approached cautiously. The risks of such duplications are operational issues (equivalent to physical-world practices such as having one key for many locks or many keys for a single lock) and are independent of the security of this invention (just as the number of keys is independent of the security of a lock's construction).

An ISPDK is physically separate from its ISPD or ISPDs, and the invention will require that at times they be physically separated. Within this constraint, multiple logically distinct ISPDs may be combined physically into a single unit, and multiple logically distinct ISPDKs may be combined physically into a single unit. In use, information may be exchanged between an ISPD and its ISPDK to assure that each ISPD and each ISPDK act distinctly from others which may be packaged in the same physical unit.

An ISPDK may be a standalone device which communicates only with an ISPD.

Alternatively, it may be a device which obtains data used in authenticating itself to the ISPD from a remote service provider of such data, termed an ISPDK Service Provider. If this is the case, then the ISPDK has an external network connection which allows communications with this service provider. This is shown in FIG. 7 as item 744, the ISPDK Service Connection.

FIG. 7 also shows diagrammatically an ISPDK. In this figure, 740 represents the ISPDK itself. 742 represents its own ISPDK Port. 730 represents the ISPDK Channel, which may and often will be a wireless communications channel. 744, the ISPDK Service Connection, represents an optional connection to an ISPDK Service Provider.

Description of the Storage Device

The Storage Device (“SD”) used with an ISPD may be of any type or class, according to the terminology developed earlier in this document. The operation of the ISPD distinguishes two general ways in which this SD may be provided. These will be termed “Local” and “Remote,” although these terms are not entirely satisfactory. The real issue is not physical proximity, but possession and control.

The SD may be a device under the control of the operator of the ISPD. For example, it may be a magnetic disk on the operator's server computer, or a USB “memory stick” used with the operator's laptop computer, or in general any other SD physically controlled by the operator of the ISPD.

Alternatively, the SD may be a device not under the control of the operator of the ISPD, but instead provided as a service by another party (either a party connected with the operator, such as another department in the operator's enterprise, or a third party not connected with the operator). This party will be known here as the Storage Device Provider (“SDP”). If this type of SD is used, the Downstream Link of the ISPD must be a network connection (such as an Ethernet link), or must be capable of communication with a network connection (such as a USB link to a network hub). In practical operation, the ISPD and the SDP will establish an encrypted Data Link (essentially a simple Virtual Private Network) over this connection to provide additional protection of the data between the SD and ISPD; the protection of this network DL is not, however, required for the security provided by the ISPD.

In both types of operation, the procedures for reading, writing, and protecting the data on the SD are identical. However, each type of operation has different security implications.

Operation

Enabling and Disabling an ISPD

An ISPD controls all information passing over the DL. It is placed “inline” between the two sides of the link, and may not be circumvented within the DL or its protocols.

Until such time as it is enabled for operation via an ISPDK, an ISPD is in a disabled state. In its disabled state, an ISPD responds to all UD requests either by refusing to respond altogether or with appropriate refuse-to-respond diagnostic codes, as the DL communication protocols and SD access protocols and the operational security situation require.

From such time as it is enabled via an ISPDK to such time as it is again disabled, an ISPD is in an enabled state. In its enabled state, the ISPD provides the appearance of the SD to the UD. This is done in a manner consistent with the DL communication protocols and SD access protocols, such that the ISPD is in this state “transparent.”

An ISPD may be disabled in any of five ways, one or more of which must be implemented in any given ISPD. These are:

(1) It may time out and disable itself after a preset time period.

(2) It may be disabled by again presenting the ISPDK (which in this use acts as a disabling key rather than as an enabling key.)

(3) It may be disabled when the SD receives a command within the SD access protocol to shut down. This method of disabling is optional and need not be implemented, as it presents potential risks for denial of service attacks.

(4) It may disable itself if it encounters an internal error condition or a situation which it considers to be sufficiently suspicious according to the security policy implemented in it.

(5) It may be disabled by being unplugged from either of its DL connections or if it loses power.

Once disabled, an ISPD maintains its disabled condition until again enabled with its ISPDK. In the case of being disabled for reason 4 (internal error or suspicious circumstances), the ISPD may also be implemented so as to choose to disable itself permanently and to disallow re-enabling without further intervention from its manufacturer.

Forced Removal of the ISPDK

Upon successful enablement, the ISPDK must be removed from communications with the ISPD within a pre-set time period. Optionally, the ISPD or ISPDK may indicate this requirement by presenting lights, sounds, or other signals. If the ISPDK is not removed within the pre-set time period, the ISPD will enter its disabled state.

This requirement is an important operational requirement of the invention. It is intended to reduce the operational risk of an ISPDK being left, negligently, with the ISPD that it enables.

This would be equivalent to locking a safe but leaving the key in the lock.

ISPD Operation Mode: Local-SD

With regard to the relationship between the ISPD and its SD, the ISPD operates in one of two modes, identified here as “Local-SD” mode and “Remote-SD” mode. An ISPD may be implemented so as potentially to provide either mode or both.

In Local-SD mode operation, the ISPD provides an SD using media and devices intended to be under the physical control of the operator of the UD.

For example, the UD might be a laptop computer, the DL to the ISPD might be a SCSI disk access protocol running over USB, the SD might be a solid-state memory device of the type commonly known as a “pen drive,” and the DL from the ISPD to the SD might be a proprietary disk access protocol running over USB.

In either Local-SD or Remote-SD operation, the logical “Basic Read/Write Cycle” as described below is the same.

ISPD Operation Mode: Remote-SD

In Remote-SD mode operation, the ISPD provides an SD using a network connection to devices and media under the control of an entity other than the same as the operator of the UD. This entity will be termed the “SD Provider.”

For example, the SD Provider may be another department in the UD operator's organization which provides data services. The SD Provider might also be a third party providing such services to its customers. Generally the SD Provider will be at allocation remote to the operation of the UD, though of course the arbitrary network topology between the Downstream Port(s) of the ISPD and the remote SD do not require any particular physical relationship or lack thereof.

As an example, the UD might be a laptop computer, the DL to the ISPD might be a SCSI disk access protocol running over USB, the SD might be a virtual DASD implemented in a Server Area Network by the SD Provider at a remote secure facility, and the DL from the ISPD to the SD might be a proprietary disk access protocol running over an encrypted link over the public Internet.

As another example, the UD might be a server, the DL to the ISPD might be a SCSI disk access protocol running over PCI, and the SD might be a Document Object Model (DOM) hierarchically structured storage device provided via HTTP over a VPN running over the public Internet.

Since the communications between the ISPD and the SD in this mode of operation may be over arbitrary and possibly insecure networks, including the public Internet, this communication link may be secured. This may be done using a key exchange algorithm such as, but not limited to, the Diffie-Hellman Key Exchange Algorithm (Diffie and Hellmann 1976), coupled with a symmetric cryptographic communications algorithm such as, but not limited to, the Advanced Encryption Standard (“AES”) run using an appropriate communications protocol. The provision of encrypted communications links of this type is common in the art, especially in the areas of Virtual Private Networks and of Electronic Commerce (see for example (Dierks 2006) for the TLS protocol). The encryption of this communications link is independent of any encryption done by the ISPD on data stored to and read from the SD in the “Basic Read/Write Cycles” described below.

In either Local-SD or Remote-SD operation, the logical “Basic Read/Write Cycle” as described below is the same.

ISPD Operation Mode: Independent Operation

An ISPD may be designed to provide either or both of two operational modes here termed “Independent” operation and “Coordinated” operation. These operational modes are themselves unrelated to Local-SD and Remote-SD operation; Independent Operation may be either Local-SD or Remote-SD, and, similarly, Coordinated Mode Operation may be either Local-Sd or Remote-SD.

In Independent Mode Operation, the ISPD and its “local” or “remote” SD form a logical pair independent of all other ISPDs. As such the ISPD protects the contents of its SD, and maintains those contents with regard only to inputs from its UD.

ISPD Operation Mode: Coordinated Operation

In Coordinated Mode Operation, the ISPD protects and maintains its SD as in Independent Mode Operation, and further ensures, via a separate Coordination Link to an external Coordinating Storage facility, that the contents of its SD are consistent with the contents of the Coordinating Storage. This is done in a manner invisible to the user of the ISPD. It requires attention to various issues of mutual consistency and may involve issues of performance and caching. These operational issues will be discussed below, after a discussion of the “Basic Read/Write Cycles” common to all operational modes.

Description: Basic Read/Write Cycles

In all operational modes, the operation of the ISPD with regard to the SD takes place using the following Read/Write operational cycles.

Read Cycle:

To perform the operation of reading data from the SD, the following steps must occur:

Step 1. The ISPD reads a Data Element (“DE”) of encrypted data from the SD.

Step 2. Optionally, the ISPD computes an appropriate cryptographic hash of this DE of encrypted data. If this step is omitted, then Step 4 must occur.

Step 3. Using appropriate cryptographic methods, as common in the art, the ISPD decrypts this DE.

Step 4. Optionally, the ISPD computes an appropriate cryptographic hash of this DE of plaintext data. If this step is omitted, then Step 2 must have occurred.

Step 5. The ISPD compares either or both of the cryptographic hashes generated in Step 2 and/or Step 4 against the appropriate cryptographic hash of this ciphertext or plaintext data, as stored previously when the data was written.

Step 6. If the comparison(s) of Step 5 match, then the ISPD delivers the data on the DL.

Step 7. If either or both of the comparison(s) of Step 5 do not match, then the ISPD does not deliver the data, and various actions may be taken depending upon the security policy implemented by the ISPD.

FIG. 8 presents a flowchart of this Basic Read Cycle. Note that if item 802 in the flowchart (step 2 above, the cryptographic hash of the encrypted data) does not occur, then 806 in the flowchart (the cryptographic hash of plaintext data) must occur.

Write Cycle for a New Data Element

This write cycle is used to write a Data Element that the Access Protocol indicates is a new data element. An example might be a block on a magnetic disk that has not previously been accessed by the ISPD, or a new block at the end of a magnetic tape, or a new node in a TASD such as an NFS filesystem.

Step 1. Optionally, the ISPD computes a cryptographic hash of the plaintext Data Element. It stores this value. If this step is omitted, then Step 3 must occur.

Step 2. Using apppropriate cryptographic methods, as common in the art, the ISPD encrypts this DE.

Step 3. Optionally, the ISPD computes an appropriate cryptographic hash of this DE of ciphertext data. It stores this value. If this step is omitted, then Step 1 must have occurred.

Step 4. The ISPD writes the DE to the SD.

Write Cycle for a Modified Data Element:

This Write Cycle is the same as the write cycle for a new DE, save that before any steps are taken with the proposed new data to be written, the ISPD first executes a Basic Read Cycle for the existing DE. If this Read Cycle executes without error (that is, if the cryptographic hash or hashes for the DE compare successfully) then the Write proceeds. Otherwise, the Write fails and various actions may be taken depending upon the security policy implemented by the ISPD.

Description of ISPDK Operation:

Enabling Signal and Other Information:

In each use, an ISPDK must pass a single signal to its associated ISPD. The meaning of this signal is that the ISPD should change its state (from disabled to enabled if previously disabled, or from enabled to disabled if previously enabled). The ISPDK need not explicitly pass this signal to the ISPD as message. Because the ISPDK must first authenticate itself to the ISPD, it may pass this bit of information by virtue of successfully authenticating itself. Having successfully authenticated itself, the ISPDK may also, optionally, pass additional information to the ISPD, including an explicit command to enable the ISPD, and optionally may receive information from the ISPD.

Authentication

The ISPDK must at the time of its use authenticate itself to the ISPD. It may do so using any authentication method. Several such methods exist in the prior art, including those described by Lamport (Lamport 1981) and those described by Kaufman (U.S. Pat. No. 5,666,415). Authentication will require cryptographically secure “Key” data, such as one or more random numbers of sufficient length, for both the ISPD and the ISPDK.

ISPDK Channel Communications Protocol:

In addition to authentication, and possibly containing the authentication session, an ISPDK and an ISPD may also establish a cryptographically secure session using a key exchange algorithm such as, but not limited to, the Diffie-Hellman Key Exchange Algorithm (Diffie and Hellmann 1976), coupled with a symmetric cryptographic communications algorithm such as, but not limited to, the Advanced Encryption Standard (“AES”) run using an appropriate communications protocol. The provision of encrypted communications links of this type is common in the art, especially in the areas of Virtual Private Networks and of Electronic Commerce (see for example (Dierks 2006) for the TLS protocol).

In addition to authentication, in order to verify, but not yet to securely authenticate, that the correct ISPDK is being used with the correct ISPD, the ISPDK and ISPD may exchange further mutual identification information (such as serial numbers).

ISPDK Operation Type A: Self-Contained ISPDK

An ISPDK may be implemented as an entirely self-contained device which stores its enabling Key or Keys.

ISPDK Operation Type B. Remotely Secured ISPDK

An ISPDK may be implemented as a device which maintains a communications link with a third party provider of services, termed the ISPDK Service Provider. The ISPDK may be implemented either to establish this link as required or to maintain it continuously. Communications over this link is encrypted, and may be further obfuscated. The ISPDK and ISPDK Service Provider may take arbitrary measures, determined as appropriate, to check this link for tampering. These measures may include, but are not limited to, periodic timestamps, checks for inappropriate time gaps, sensing of physical tampering with the ISPDK, sensing of electromagnetic or other interference with the ISPDK, irregularities in the communications protocol, detection of apparent use simultaneously with an imposter ISPDK, and so forth. Actions taken if tampering or other security violations are detected may include temporarily or permanently disabling the ISPDK, notifying the SD Provider (if present), and notifying the operator of the ISPD and UD.

In this mode of operation, the ISPDK does not store its enabling Keys but obtains these keys dynamically from the ISPDK Service Provider.

ISPD Operation: Policy Enforcement

An ISPD itself has a uniquely privileged view of the contents of its associated SD: it can see them in their entirety, and because it possesses their encryption keys (and indeed is doing the encryption of the SD) can see them in cleartext. Thus in addition to encrypting the data on an SD, an ISPD is uniquely positioned to perform additional operations on that data. For example, in Coordinated Mode operation, an ISPD ensures that the contents of the SD are effectively identical to the contents of external Coordinating Storage.

This present invention recognizes this unique position of an ISPD as also being an ideal position to protect the data from abuse, whether intentional or accidental, by legitimate users of the data. This is done through the enforcement of “Policy” (discussed in this section) and “Auditing” (discussed later).

An ISPD can enforce on the use of the data the SD any Policy defined by the owner of that data which may be implemented by an arbitrary computer program. This programmatically defined Policy is set to an initial programmatic state at the manufacture of the ISPD. If the ISPD contains a Control Port, the programmatic definitions of this Policy may be updated periodically by an external Control facility.

For example, the simplest of all policies is the null policy which allows the user unrestricted access to all data on the SD.

In another example, a data owner who wishes to guard against wholesale copying of a large database, yet who needs an employee to have potential access to all parts of such a (presumably large) database, might define a limit to the number of database records that a user might access on the SD. A single user could therefore never steal the entire database.

Alternatively, the programmatic definition of the Policy might limit the rate at which records may be accessed. Such policy would guard against automated copying of the database, and would also detect copying at rates faster than ordinary legitimate use.

In another example, a user might initially have access to an entire filesystem of documents representing many customers. Access by a single employee to the documents of both of two particular customers may be forbidden; for example, once an accountant has seen the data for customer A, that accountant might henceforth be forbidden, as a matter of company policy, from viewing the data for customer B. An ISPD can enforce such Policy, yet the employee may physically possess the entire filesystem of documents/data on the SD. (In this way, for example, a company might distribute identical copies of a database to all employees simply by making many copies of a USB memory stick, yet still enforce Policy which denies access to some of that data by particular employees in particular circumstances.)

While the examples above involve the reading of data, an ISPD may also enforce policy on the writing of data. For example, a user whose use has been detected as suspicious by the programmatic Policy defined to the ISPD may be forbidden to modify certain items of data, or to delete them, or to write new data in certain circumstances. This protects against the corruption, either malicious or accidental, of data by legitimate users.

Clearly, an combination of access conditions and rates of retrieval may be enforced, up to the limits of that which is expressible in a computer program.

The Policy capabilities of an ISPD may be constructed so as to be invisible to a user unless (of course) the user transgresses Policy boundaries and is unable to accomplish some desired read or write activity.

ISPD-Operation: Auditing

In addition to enforcing Policy, as described earlier, an ISPD is also well positioned to conduct auditing of the use of data on the SD. It is responsible for the reading and writing of all data from and to the SD, so it can potentially record each transaction. For reasons of economy of storage, it may be programmed to record fewer transactions, or to record transactions only when some Policy circumstances indicate it. The programmatic specification of Auditing is thus separate from, but not unrelated to, the programmatic specification of Policy.

Audit records so kept may be kept on the ISPD itself. If the ISPD contains a Control Port, they may also be written to a remote Control facility. If the ISPD contains a Control Port they may, further, also be written to any other arbitrary facility. For example, an ISPD may record all access to some particular data item X, and may copy that audit record to the Control Facility, and may further copy that record to a third-party auditing firm. The Auditing capabilities of an ISPD may be constructed so as to be invisible to the user.

Operation—Analysis of Threats

Analysis of Threats. Exposure of Data to an External Attacker

Issue Addressed. Keys and Key Management:

The Basic Read/Write Cycles of this invention, described earlier, incorporate within them standard methods for encrypting data on the SD. These methods are well-known in the art, and have been well-analyzed in the literature. Particular mention may be made of the “Loop-AES” encrypted disk implementation (Ruuso 2001ff).

In all encryption, the security of the encrypted data depends upon the secrecy of the decryption key. (In “symmetrical” encryption scenarios, the encryption and decryption keys are identical; in “public key” scenarios, the encryption and decryption keys differ. In both, the decryption key must remain known only to those authorized to decrypt the data.) Since the decryption key must be present in or presented to the Computing Environment in order to decrypt encrypted data, and the encryption key to encrypt data, “key management” becomes a central issue in practical data encryption.

Clearly the key itself cannot be stored in the Computing Environment. That would be analogous to locking a safe with a key but leaving the key in the lock. Yet at the same time the Computing Environment must be able to detect that a key presented to it is or is not the correct key, because the application of decryption algorithms to encrypted data using the wrong key might result in undetected data corruption.

One solution to this problem in the prior art is to store not they key but a cryptographically secure “hash” of the key in the Computing Environment. In this method of operation, when a key is presented to decrypt data it is hashed using the same algorithm. If the key's hash value matches the stored hash value, they key is taken to be correct. This method allows the detection of key correctness, yet does not allow the key itself to be derived from the stored cryptographic hash value. This method is used in prior art such as Loop-AES.

These methods remain flawed, however, in part because in order to be used a key (decryption or encryption) must be stored somewhere in the Computing Environment during its use. For example, in Loop-AES it is stored in the computer's RAM while data on disk is encrypted and decrypted. An attacker of sufficient skill might penetrate the Computing Environment and seize this key. It might be argued that this is not significant, since such an attacker would also be able to read the plaintext data as it is being used. While this is true, this problem remains because the attacker might read the key at one point in time, then wait until different data has been written to the disk, then access the disk (which might at that time be unmounted and presumed secure) at another point in time.

Another significant issue in key management concerns the size and randomness of the key itself.

In situations where an attacker may be presumed to have very limited access to the Computing Environment, and may therefore only test relatively few potential keys, all that is required is that it be unlikely that an attacker might guess the key in these few attempts.

However, the general situation with SDs is one where an attacker must be assumed to have practically unlimited access to the SD. For example, an attacker might steal or surreptitiously duplicate the contents of an encrypted SD. The attacker might then set up an attack environment where many millions of potential keys might be tried. Such an attack is termed in the art a “dictionary attack” because one such method is simply to try every word in the dictionary as a key, together with systematic combinations and permutations of them. In the present state of the art, a dictionary attack against an encrypted SD such as a hard disk which is encrypted with a key which is other than a sufficiently long random number is generally presumed to have a high chance of success.

The solution is to employ only keys which are sufficiently long random numbers, where the definition of “sufficiently long” changes as encryption algorithms and knowledge of attacks on them evolve. This introduces a consequent problem, however, well known in the art: such a key cannot be remembered and/or typed by a human operator, and so must itself be stored on a device. This device, when incorporated into the Computing Environment to supply the key, itself becomes a target of attack.

For example, in Loop-AES one possible operational configuration consists of one or more long random number keys stored on an external removable medium such as a USB memory device. This solution is the best that the prior art allows, but suffers from the two disadvantages that the device so used is vulnerable while in use and also is vulnerable while not in use.

A final issue of key management in the practical operation of Computing Environments is simply that of ensuring that appropriate keys are used. Key management as it exists in the prior art introduces additional operational steps that are time-consuming and confusing to ordinary operators and good key management practices are therefore often circumvented by the very users they are designed to protect.

This invention addresses all of these general issues in key management.

Issue Addressed. Exposure of Keys:

It addresses the issue of the potential exposure of keys within the Computing Environment by removing the keys from the general Computing Environment. All encryption and decryption is done on the ISPD, which is a separate device the internal operations of which are not accessible to the rest of the Computing Environment. The key or keys are generated on the ISPD and are stored within the ISPD. They are never revealed to any other portion of the Computing Environment.

Issue Addressed. Theft of Keys:

It addresses the issue of the potential theft of the key from an insecure external device (such as a USB memory device, in the Loop-AES example cited above) by these same means: the key or keys are stored only within the ISPD, and the ISPD, while a separate device subject to theft, is specifically a device intended for security and thus may be implemented in such a way as to resist attack. This is not in general practical with an SD, where the emphasis is on storage rather than security.

Moreover, in many implementations in the prior art the key-storage device may be, or in best practice should be, removed after its initial use (so as to prevent its access by an attacker). This leaves this key-storage device open to theft while the SD is in use, and such theft would be undetectable from within the Computing Environment. The ISPD, by way of contrast, is required to be present throughout the use of the SD. Its theft would be detected immediately (because the SD would cease to function).

Issue Addressed. Operational or Administrative Issues:

Finally, this invention addresses the issue of the use of cryptographically sufficient keys removing the operational matter of key generation and use from the hands of the operator. The ISPD generates keys automatically and invisibly. The operator or user need never enter a key, nor even be aware that the ISPD is present and that the SD is encrypted.

Analysis of Threats: Exposure of Data to a Legitimate User or Internal Attacker

This threat is addressed by the required Policy and Auditing capabilities of the ISPD.

No mechanical or programmatic means can completely eliminate the risk of the theft of data by a legitimate user, or the accidental or malicious misuse of data by a legitimate user. The ultimate situation, of course, is that where a user simply reads a piece of critical information from a computer screen (or printout or other medium) and misuses that information. Barring the integration of human beings with machines (but see (Bush 1945)), this is fundamentally a human and management issue.

However, significant programmatic limitations can be placed on the use of data which mitigate this potential for theft or misuse by the enforcement of “Policy” (as described earlier) on the data. The present invention provides for the enforcement of such Policy at, or more accurately just before, the point of exposure of the data as it is read from and written to a Storage Device.

The Auditing capabilities of the invention further this end. Auditing has the additional advantage that it may allow situations to be monitored as they develop (and thus allow damage to be prevented) and may be forensically reconstructed after they have occurred (and thus allow damage to be mitigated or repaired).

Analysis of Threats: Falsification of Existing Data by an External Attacker

Subject to the key managements limitations discussed above, the prior art such as Loop-AES addresses issues of the security of data on an SD. The prior art does not, however, address the issue of the falsification of data on an SD.

An attacker who has in some manner obtained the key or keys used for data encryption (and decryption) may of course simply read the encrypted data. This is a serious issue, and has been the primary focus of concern in the art. In many circumstances, however, a potentially serious concern arises because such an attacker would also be able to alter data on the SD by writing modified or new data to the SD using the same encryption methods as used for legitimate data. From the point of view of the cryptographic process, such data would be indistinguishable from genuine data.

The use of cryptographic hashes of plaintext or ciphertext data, as described in the Basic Read/Write Cycles of this invention, addresses this issue.

Suppose that an attacker has gained access to the SD bypassing the ISPD, and suppose further that this attacker has been able to cryptanalyze from the encrypted data on the SD one or more keys used to encrypt that data. If then an attacker attempts to write false data to the SD, encrypting it using the same key, neither, the cryptographic hash of the false data so written nor of its encrypted version will match the hash stored in the ISPD. The ISPD will thus be able to detect this situation, refuse to present the falsified data to the UD, and raise an appropriate error or warning alert.

Analysis of Threats: Falsification of Data by a Legitimate User or Internal Attacker

This threat is addressed by the Policy and Auditing capabilities of the ISPD, as discussed under the “Analysis of Threats: Exposure of Data to a Legitimate User or Internal Attacker” section above.

Analysis of Threats: Injection of False Data by an External Attacker

This situation is analogous to the falsification of existing data. Several types of SD are non-finite in nature and therefore allow the potential for new false data to be added to them by an attacker. A magnetic tape is an example of such an SD.

The operational model of the ISPD precludes this type of attack, however. When an ISPD is first enabled, it has stored within it no cryptographic hashes for any blocks; it contains the information, therefore, that it is newly initialized. In operation, an ISPD generates cryptographic hash information for each block of data as it is encountered. This information is retained between successive enablings. At all times, the cryptographic hash information stored in the ISPD must match exactly the corresponding information derived from the SD.

If an attacker were to add correctly encrypted but false new data to the SD, the cryptographic hash of that data would correspond to no stored value in the ISPD. The ISPD would therefore regard it simply as if it were un-used storage set to arbitrary values.

Analysis of Threats: Injection of False Data by a Legitimate User or Internal Attacker

This threat is addressed by the Policy and Auditing capabilities of the ISPD, as discussed under the “Analysis of Threats: Exposure of Data to a Legitimate User or Internal Attacker” section above.

Analysis of Threats: Deletion of Data by an External Attacker.

This is a subset of the threat of falsification of data, where the false data is the special case of null data. This invention can, as described in the “Falsification of Existing Data” threat analysis, detect such a situation.

Analysis of Threats: Deletion of Data by a Legitimate User or Internal Attacker

This threat is addressed by the Policy and Auditing capabilities of the ISPD, as discussed under the “Analysis of Threats: Exposure of Data to a Legitimate User or Internal Attacker” section above.

Analysis of Threats: Non-Uniformity of Data in Coordinated Mode Operation

This threat is a straightforward extension of the Falsification of Existing Data threat (by either External or Internal Attackers), as described earlier. To render the data non-uniform over multiple coordinated ISPD/SD pairs is equivalent to falsifying it on a single SD.

### DETAILED DESCRIPTION

### Preferred Embodiment

The generality of possible deployment situations for this invention suggests that there are many possible embodiments of it, and indeed many embodiments which easily might be considered “preferred.” The selection of this first “Preferred Embodiment,” therefore, is to some extent arbitrary. It has been highlighted as the “Preferred” embodiment primarily because it represents a very simple operational scenario. The Alternative Embodiments suggested later, and other embodiments, are no less preferable in their own contexts.

A preferred embodiment of this invention consists of an ISPD implemented to protect SDs of the DASD classification. In one such preferred embodiment, the Usage Device would be a conventional laptop computer with an external Universal Serial Bus (“USB”) port, the Data Links would be USB links, and the Storage Device would be a solid-state USB-attached “memory stick” (of the type also known as a “pen drive”). The ISPD Upstream Port and Downstream Ports would be USB ports. The ISPD would implement USB protocols and the appropriate SD Access Protocol, such as SCSI, for operating the SD. This ISPD/SD pair would be operating in “Local-SD” mode operation. There would be no Control Port. All programmatic definitions of Policy and Auditing would be pre-loaded into the ISPD at manufacture, and all audit data would be retained on the ISPD, invisible to an ordinary user, for potential forensic use. There would be no Coordination Port. This ISPD/SD pair would be operating in Independent, not Coordinated, mode operation. Such a preferred embodiment is shown in FIG. 11.

### OPERATION

### Preferred Embodiments

The operation of an ISPD in this embodiment would proceed as described in the Detailed Description and in the Operation sections, above.

For ISPD operation, in Local-SD, Independent mode, such as this would be, an operator of an ISPD would connect the ISPD 1108 to the Usage Device 1100 and an SD 1132 to the ISPD 1108. The operator would then use the ISPDK 1122 to enable the ISPD 1108. The first time that this was done, the ISPD would “see” a Storage Device as a new storage device; it would ignore any data which happened to pre-exist on the SD.

The ISPD would, when enabled and when requested to read or write data from or to the SD, follow the Basic Read/Write Protocols as described above.

The ISPD, would have been initialized with Policy and Auditing programs at manufacture. Since it has no Control Port over which these might be modified, these initial Policy and Auditing programs would persist over the entire operational life of the ISPD. The ISPD would enforce Policy and conduct Auditing at all times.

In addition to securely providing data with an SD of this class, this embodiment presents a number of operational advantages. It protects a type of SD, a USB “memory stick,” which is particularly subject to theft. It provides ease of use in a portable environment: a user might leave the computer-ISPD-SD combination disabled in a relatively insecure location and carry on their person only the ISPDK, for example. It may also be employed without modification in an existing Computing Environment. There is no need, in this embodiment, to make any provision in the laptop computer, the USB data links, or the USB “memory stick” for the ISPD technology of this invention; it is transparent.

While ISPD operation in Remote-SD mode is not logically impossible with this particular embodiment, long-distance network communications are not common using the USB communications medium. An embodiment more suitable for Remote-SD operation is described in the Alternative Embodiments section below.

### DETAILED DESCRIPTION

### Alternative Embodiments

An alternative embodiment of this invention would be similar to the preferred embodiment described above, but in addition the ISPD would contain a Control Port over which its Policy and Auditing programs might be updated. This is shown diagrammatically in FIG. 12.

Another alternative embodiment of this invention employ two ISPD/ISPDK/SD Computing Environments in both Local-SD and Remote-SD Coordinated Operation. This is shown diagrammatically in FIG. 13.

Another alternative embodiment of this invention would be similar to the preferred embodiment described above, but use an Ethernet network link for the Downstream Port, possibly further linked to an enterprise's intranet or to the public Internet. This embodiment would permit ISPD Operation in Remote-SD mode. In this type of operation, the ISPD and the remote SD provider would implement a cryptographically secure data link (effectively a Virtual Private Network, or “VPN”) for communications between the ISPD and the SD. The remote SD might be, for example, an Ethernet-capable network-attachable disk disk (an appropriate disk access protocol, such as SCSI, would run on top of these network services). This is shown diagrammatically in FIG. 14.

Another alternative embodiment of this invention would consist of an ISPD implemented to provide security to an SD which was a portion of the RAM of an otherwise conventional computer. In an embodiment of this type, the Usage Device would be the processor or processors of the computer, the Data Links would be a memory bus within the computer, and the Storage Device would be Random Access Memory (“RAM”). In this embodiment, the Access Protocol for the SD is simply the memory addressing scheme, possibly including virtual memory addressing, of the computer. This is shown diagrammatically in FIG. 15

Another alternative embodiment of this invention would consist of an ISPD implemented to provide security to an SD which was a set of documents served over the World Wide Web (“WWW”) by a Hypertext Transport Protocol (“HTTP”) server. Such a server and its document set is in fact a TASD, although it is not always thought of in such terms. It's use as a TASD meets all of the criteria for the Basic Model. The UD is the user's web-accessing device (such as a “browser”). The DL is a TCP/IP network such as the public Internet. The SD is a virtual device presented by the HTTP server. The Access Protocol is HTTP (possibly in combination with the Document Object Model (“DOM”)); which provides access in a tree-structured manner to individual documents and (when DOM is used) to individual fields within these documents. This situation described in this manner constitutes a read-write (for an administrator) or read-only (for a user) SD within a networked or distributed Computing Environment. This is shown diagrammatically in FIG. 16.

As is well-known in the public media, this situation is exposed to many security threats. One threat of particular importance to many providers of SDs (websites) is the unauthorized modification of the data of these SDs (web pages) in, for example, acts of deliberate vandalism. In this embodiment, an ISPD would be implemented such that its Upstream and Downstream Ports implemented the HTTP protocol, together with the underlying layers of TCP/IP and physical network protocols required to transport HTTP. The SD (a TASD) would be the Downstream web server. It would first be initialized with its content in read/write operation, by an administrator. Best practice might during this time sever all other network connections to the HTTP server. It would then be disabled and then re-enabled in read-only mode. At this point, the ISPD would effectively “re-serve” the data on the TASD (the website) in a read-only fashion. The Data Element of one possible embodiment would be an entire document. In read/write operation, the ISPD would write this DE (a document) in encrypted fashion to the HTTP server (using for example HTTP “PUT” commands) and read the document in encrypted form from it, in each case using the Basic Read/Write Cycle as described earlier. In read-only mode, the ISPD would refuse write (PUT) operations and satisfy only those operations compatible with reading.

If an attacker were to subvert the HTTP server, the data (documents) on it would be encrypted and therefore themselves secure. If an attacker were to change these documents (for example, to deface a website), the ISPD would detect these as changed documents and refuse to serve them. It thus provides a fail-safe (in the technical sense—failure results in continued safe operation) of a website against defacement.

This alternative embodiment has been described in terms of a read-only user, as is common in the World Wide Web of the present time. However, in a different usage scenario an alternative embodiment resembling this one might be used by an ordinary user for ordinary read/write data storage on the TASD.

Another type of alternative embodiment is characterized not by the class of SD but by the serial arrangement of ISPDs on a DL. If two or more ISPDs are placed serially on a single DL, this does not violate the principle that only one ISPD must control access to an SD, because only the final ISPD in the series works directly with the SD. The other ISPDs work indirectly not with the data on the SD itself but with that data as presented by the ISPD on their “Downstream” side. Each ISPD after the one closest to the SD therefore receives encrypted data and re-encrypts that data for presentation on its “Upstream” side. This is shown diagrammatically in FIG. 17.

This multiple encryption of data may or may not provide cryptographic advantages. It does, however, provide an operational advantage which may be of importance in certain situations. Given such a serial arrangement of ISPDs, all ISPDs in the series must be enabled in order for data to be written from the UD to the SD, and for data on the SD to be read back to the UD. Since each ISPD may be enabled by a different ISPDK, and since these ISPDKs may be distributed among multiple parties, this effectively constitutes a “voting” system for data access in which all parties must concur that access should be allowed (by using their ISPDK to enable their ISPD).

One possible application of this embodiment would be in a data equivalent of a safe deposit box, where both the owner of the data (corresponding to the holder of the safe deposit box) and an authority (corresponding to a bank manager) must present their ISPDKs (their safe deposit box keys) to access the data. Another application would be in a data escrow situation, where multiple nominally equal parties who do not trust each other (and potentially trusted third parties as well) must all present their ISPDKs in order to access the data.

Many other alternative embodiments are possible. For example, alternative embodiments exist for each class of SD (for example, for SPASD, SASD, RelASD, etc.) and, within each class, for each type of Data Link, Storage Device, and Access Protocol.

### OPERATION

### Alternative Embodiments

In each of the alternative embodiments described above, operation would proceed as described in the general Operation description earlier.

The first alternative embodiment, shown in FIG. 12, would operate in the same fashion as the preferred embodiment (FIG. 11), except that as it additionally contains a Control Port 1214 and a link 1226 to an external Control Facility, its Policy and Audit programs could be updated as desired.

The second alternative embodiment, shown in FIG. 13, contains a Computing Environment 1351 which would operate in a Local-SD mode manner similar to the alternative embodiment of FIG. 12, and a Computing Environment 1359 which also would operate in a similar manner, except that its SD 1392 is a Remote-SD. However, in this embodiment the ISPDs 1308 and 1368 of each Computing Environment each operate in Coordinated mode operation and each maintain the contents of their SDs as effectively identical to a Storage Device provided by the external Coordinating Storage facility 1399.

The third alternative embodiment, shown in FIG. 14, operates in a manner similar to the preferred embodiment. (FIG. 11), except that the Downstream DL 1428 is an Ethernet network connection (with an appropriate disk access protocol running atop it) and the SD 1432 is an Ethernet-capable network-attached disk drive.

The fourth alternative embodiment, shown in FIG. 15, operates in a manner which is functionally similar to the preferred embodiment (FIG. 11), even though its UD, DL, and SD components are all apparently technologically dissimilar to the preferred embodiment of FIG. 11. In this alternative embodiment (FIG. 15), the Usage Device (UD) 1500 is a computer processor such as an ordinary commercial microprocessor. The Data Link (DL) 1504 between the UD/Processor 1500 and the ISPD 1508 is a memory bus such as might be implemented on a microcomputer motherboard. The Storage Device (SD) 1532 is semiconductor RAM as might be found on a conventional microcomputer, and the DL 1528 between the ISPD 1508 and the SD 1532 is, like DL 1504, a memory bus. Although the preferred embodiment of FIG. 11 might reasonably be implemented as a pocket-sized device connecting a laptop computer via cables to a USB memory stick, while this present alternative embodiment might be implemented on a microcomputer motherboard itself (with appropriate physical access for ISPDK 1522), their operation is functionally similar from the point of view of this invention.

The fifth alternative embodiment, shown in FIG. 16, operates again in a functionally similar manner (especially with regard to the preferred embodiment of FIG. 11), except that in this embodiment the Downstream DL 1628 between ISPD 1608 and SD 1632 is a TCP/IP protocol suite connection over the public Internet and the SD 1632 is a Hypertext Transport Protocol Daemon (HTTPD) server serving a repository of Document Object Model (DOM) structured documents (that is, in the terminology of this invention, it is a TASD).

The sixth alternative embodiment, shown in FIG. 17, contains two ISPDs 1708 and 1768 configured serially. These form two distinct computing environments, CE 1 (1750) and CE 2 (1752). As can be seen from FIG. 17, these two environments overlap.

CE 1 (1750) contains a Laptop Computer 1700 as its UD, a USB link 1704 as the Upstream DL between Laptop/UD 1700 and ISPD 1708, an ISPD 1708 (together with its ISPDK 1722 and ISPDK Ports and Channel 1716, 1720, and 1718), a USB link 1728 as the Downstream DL between ISPD 1708 and the SD, and a Storage Device (SD) which is in fact Computing Environment CE 2 (1752) as presented through ISPD 1768.

CE 2 (1752) has as its Usage Device CE 1 (1750), as seen over USB link 1728 (which is an Upstream DL from the perspective of CE 2) from ISPD 1708. CE 2 contains, in turn, its own ISPD 1768 (and ISPDK 1782, etc.) and USB drive 1792 as its SD.

This alternative embodiment thus contains two ISPDs in a serial topology. The operational advantages of serial combinations of multiple ISPDs have been discussed earlier.

### CONCLUSION, RAMIFICATIONS AND SCOPE

In conclusion, the reader will see that the ISPD and ISPDK as described here provide a mechanism for securing data on a Storage Device (possibly a remote Storage Device) which protects against the exposure of that data to an attacker, even if the Storage Device is stolen by the attacker, and which protects against the introduction by an attacker of false data. The devices also permit either independent operation or the coordination of multiple Storage Devices in such a way that each remains secure in the event of the compromise of another. The devices also permit the enforcement of usage and modification policy and the conducting of auditing on the usage of data and the Storage Device in such a way that the policy and auditing enforcement shares in the security of the protection of the Storage Device.

Additionally, the devices present several operational advantages. They are simple and intuitive to use, as they may be plugged in to existing configurations. They require the physical use of the ISPDK, thus denying many automated or network-based attacks. Because they require the ISPDK to be removed after use, they protect an operator against the operational mistake of leaving an ISPDK insecurely coupled with its ISPD.

A reader familiar with the art will also observe that this invention presents a novel unified paradigm for organizing the components of a Computing Environment. This invention therefore allows the use of a single common technology over a range of situations not typically considered as related in the prior art. It uses a single Basic Model, with a single set of Basic Read/Write Cycles, a unified conception of an ISPD device, and a single conception of an ISPDK device and its use with an ISPD over a range of deployments which goes from the very smallest scale possible (for example, between an ALU and registers) to the very largest scale possible (the general public Internet). This is an approach of extraordinary novelty.

While the description of this invention includes many details, including a new terminology, these should not be construed as limiting the scope of this invention, but rather as exemplifications of various preferred embodiments of it. Many other variations are possible, including the use of this invention with SASD (such as magnetic tape drives and farms), RelASD (Relational Databases as Storage Devices), and SPASD (such as stacks or queues).

Thus the scope of this invention should be determined by the appended claims and their legal equivalents, and not by the examples given.

### REFERENCES

[Avax 2006] AVAX International. “PARANOIA2 Family of Hardware Tape Encryption Units.” http://www.avax.com/paranoia2_family.html
[Bellovin and Merrit 1994] Bellovin, Steven M. and Michael Merritt. “An Attack on the Interlock Protocol When Used for Authentication.” IEEE Transactions on Information Theory. Vol. 40, No. 1 (January 1994): 273-275, and (1993 version) http://www.cs.columbia.edu/˜smb/papers
[Bush 1945] Bush, Vannevar. “As We May Think.” Atlantic Monthly. (July 1945).
[Collins-Sussman 2002]. Collins-Sussman, Ben, Brian W. Fitzpatrick, C. Michael Pilato. Version Control with Subversion. 2002-2005. http://svnbook.red-bean.com/
[Date 1975] Date, C. J. An Introduction to Database Systems. Reading, Mass.: Addison-Wesley Publishing Co., 1985.
[Dierks 2006] Dierks, T. “The Transport Layer Security (TLS) Protocol, Version 1.1” Internet Engineering Task Force (IETF) Request for Comments (RFC) 4346. 2006. http://tools.ietf.org/rfc4346
[Diffie and Hellmann 1976] Diffie, Whitfield and Martin Hellmann. “New Directions in Cryptography.” IEEE Transactions on Information Theory. Vol. IT-22, No. 6 (November 1976): 644-654.
[Fruhwirth 2005] Fruhwirth, Clemens. “New Methods in Hard Disk Encryption.” Vienna,
Austria: Vienna University of Technology, 2005. http://clemens.endorphin.org/nmihde/nmihde-A4-ds.pdf
[FSI 1992ff] Fundamental Software, Inc. “FLEX-ES Documentation [collection]”. Fremont, Calif. and Arbuckle, Calif.: Fundamental Software, Inc., 1992 to the present. http://www.funsoft.com/ and http://support.funsoft.com/
[FSI 2005a] Fundamental Software, Inc. “FLEX-ES Control Unit Behavior: FLEXCUB.” Arbuckle, Calif.: Fundamental Software, Inc., 2005. http://www.funsoft.com/ and http://www.funsoft.com/flexcub-wp-2005-02.pdf
[FSI 2005b] Fundamental Software, Inc. “FLEX-ES Control Unit Behavior: FLEXCUB Data Sheet.” Arbuckle, Calif.: Fundamental Software, Inc., 2005. http://www.funsoft.com/ and http://www.funsoft.com/flexcub-ds-2005-02.pdf
[FSI 2007] Fundamental Software, Inc. “Fundamental Software's Data Backup and Disaster Recovery Services.” Arbuckle, Calif.: Fundamental Software, Inc., 2007. http://www.funsoft.com/ and http://www.funsoft.com/fsi-dr.pdf
[Garrett, Paul] Making and Breaking Codes: An Introduction to Cryptology. Upper Saddle River, N.J.: Prentice-Hall, 2001.
[Holzer 2004] Holzer, Ralf. “Cryptoloop HOWTO.” 2004-01-15 and updates. http://www.tldp.org/HOWTO/Cryltoloop.HOWTO/
[Lamport, L] “Password Authentication with Insecure Communication.” Communications of the ACM. 24.11 (November 1981): 770-772.
[Luminex 2006] Luminex Software, Inc. “Channel Gateway 3400.” http://luminex.com/products/channel_gateway_{—}2400_desc.html [circa 2006; URL no longer valid]
[Microsoft 2007] Microsoft Corporation. “Cryptography Reference.” 2007. http://www.msds2.microsoft.com/en-us/library/aa380256.aspx
[MySQL 1997] MySQL AB. MYSQL 3.23, 4.0, 4.1 Reference Manual. MySQL AB, 1997-2007. http://www.mysql.org/
[Optica 2006a] Optica Technology, Inc. “Protection Series: Eclipz ESCON Data Encryptor.” Circa 2006. http://www.opticatech.com/products_protection.html and http://www.opticatech.com/products_protection_eclipz.html.
[Optical 2006b] Optica Technology, Inc. “ECLIPZ ESCON Data Encryptor.” October 2006. http://www.opticatech.com/protection/eclipz/Eclipz_Data_Sheet_Oct_{—}06.pdf
[Ruusu 2001ff] Jari Ruusu, et. al. “Loop-AES” [software package and associated files]. Apr. 11, 2001 and updates to the present. http://loop-aes.sourceforge.net/ or http://sourceforge.net/projects/loop-aes/
[Saout 2.6] Saout, Christophe. “dm-crypt: a device-mapper crypto target.” [no date; Linux kernel series 2.6] http://www.saout.de/misc/dm-crypt/
[Schneier 1996] Schneier, Bruce. Applied Cryptography. Second Edition. NY: John Wiley and Sons, 1996.
[Sun 1989] Sun Microsystems, Inc. “NFS: Network File System Protocol Specification.” Internet Engineering Task Force (IETF) Request for Comments (RFC) 1094. March 1989. http://tools.ietf.org/html/rfc1094
[Sun 2003] Shepler, S., et. al. “Network File System (NFS) Version 4 Protocol.” Internet Engineering Task Force (IETF) Request for Comments (RFC) 3530. April 2003. http://tools.ietf.org/html/rfc3530
[W3C DOM 1 1998] Apparao, Vidur, et. al. “Document Object Model Level 1 Specification.” World Wide Web Consortium, 1 Oct. 1998. http://www.w3c.org/DOM/DOMTR/ and http://www.w3c.org/TR/1998/REC-DOM-Level-1-19981001/
[Zalewski and Purczynski 2003] Zalewski, Michal and Wojciech Purczynski. “Juggling with Packets: Parasitic Data Storage.” 2003. Reprinted in (Zalewski 2005: 234-241).
[Zalewski 2005] Zalewski, Michal. Silence on the Wire: A Field Guide to Passive Reconnaissance and Indirect Attacks. San Francisco, Calif.: No Starch Press, 2005.

### PATENT REFERENCES

[U.S. Pat. No. 5,666,415] Kaufmann, Charles W. “Method and Apparatus for Cryptographic Authentication.” U.S. Pat. No. 5,666,415. Sep. 9, 1997.

We claim:

1. In a computing environment containing at least
(a1) one or a plurality of storage devices, possibly varying in number and type over time, which may be storage devices controlled by the user of the computing environment or storage devices provided by other parties, and
(a2) one or a plurality of usage devices, possibly varying in number and type over time, in which
(a3) storage devices and usage devices may be configured in possibly complex and time-variant topologies over one or a plurality of data links,
a pair of two devices, one of which is termed an inline storage protection device key and the other of which is termed an inline storage protection device, such that
(b1) for every inline storage protection device there is exactly one inline storage protection device key, and
(b2) the inline storage protection device key is physically distinct from the inline storage protection device, and
where the inline storage protection device key is furnished with physical components including at least
(c1) a communications port for communications with the associated inline storage protection device
(c2) sufficient computational capacity and data storage, and appropriate programming, to accomplish cryptographically secured authentication between itself and the associated inline storage protection device, using any appropriate cryptographic authentication technique in the art,
(c3) optionally, an external communications and data port over which the programming and cryptographic authentication keys for the inline storage protection device key may be dynamically supplied during use,
where in operation the inline storage protection device is generally disabled for operation unless specifically enabled by the inline storage protection device key for operation, in such a way that
(d1) upon physical presentation by a user to the inline storage protection device, the inline storage protection device key authenticates itself to the inline storage protection device and either through the fact of this authentication or through an explicit message then communicated causes the inline storage protection device to change its state from disabled to enable, or from enabled to disabled, and
(d2) after use with the inline storage protection device the inline storage protection device key must be removed from proximity of and communication with the inline storage protection device,
and where the inline storage protection device is furnished with at least the following physical components
(e1) one or a plurality of communications and data connections, termed upstream ports, to one or a plurality of usage devices,
(e2) one or a plurality of communications and data connections, termed downstream ports, to a single storage device, which however may be a composite storage device consisting of many storage devices presenting a unified exterior appearance as a single storage device, as is common in the art,
(e3) a communications port for communications with the associated inline storage protection device key
(e4) optionally, a single data and communications connection, termed a control port, over which connections to an external service, termed a control facility, may be established,
(e5) optionally, a two-position switch the position of which determines operation in read-only mode or in read-write mode as the terms are commonly understood in the art,
(e6) optionally for any upstream port, a similar switch,
and also is furnished with at least
(f1) computational capacity and appropriate programming to implement the encryption of a storage device, using any appropriate cryptographic technique in the art,
(f2) computational capacity and appropriate hardware and appropriate programming to implement all necessary protocols for communication and data exchange with usage devices and storage devices,
(f2) computational capacity and data storage, and appropriate programming, to accomplish cryptographically secured authentication between itself and the associated inline storage protection device key, using any appropriate cryptographic authentication technique in the art,
(f3) computational capacity and appropriate hardware and appropriate programming to implement all necessary protocols over its control port, if that control port is present,
(f4) storage capacity sufficient to contain one or more cryptographic keys used to encrypt a storage device,
(f5) storage capacity sufficient to contain cryptographic hashes of all data required for encrypting a storage device
(f6) computational capacity and appropriate programming to implement usage policy and auditing of data on a storage device,
(f7) storage capacity sufficient to maintain such local auditing records as necessary, and optionally also furnished with other hardware including without limit any or all of
(g1) a realtime clock, or
(g2) a hardware random number generator, or
(g3) other computational capacity as appropriate including capacity for selfmonitoring and diagnostic service,
which may be deployed such that
(h1) the inline storage protection device may be attached via one or a plurality of data and communications media, each generally termed a data link, to any usage device or via data links to any plurality of usage devices, and
(h2) the inline storage protection device may be attached via one or a plurality of data and communications media, each generally termed a data link, but not necessarily of the same type as those identified in (h1) above, to a single storage device, which however may be a composite storage device consisting of many storage devices presenting a unified exterior appearance as a single storage device, as is common in the art,
(h3) but notwithstanding this, all data links from a particular storage device must initially pass through a single inline storage protection device, and
(h4) each inline storage protection device optionally may have a separate communications and data link to an externally maintained service termed a control facility, and
(h5) a plurality of inline storage protection devices may be present in series on a data link or plurality of data links,
where the inline storage protection device performs cryptographically secured read and write operations on the storage device attached to it subject to a protocol such that
(i0) for read operations the following steps are taken,
(i1) the inline storage protection device reads a data element of encrypted data from the storage device,
(i2) optionally, the inline storage protection device computes an appropriate cryptographic hash of this data element of encrypted data, but if this step is omitted, then step (i4) must occur,
(i3) using appropriate cryptographic methods, as common in the art, the inline storage protection device decrypts this data element,
(i4) optionally, the inline storage protection device computes an appropriate cryptographic hash of this date element of plaintext data, but if this step is omitted, then step (i2) must have occurred
(i5) the inline storage protection device compares either or both of the cryptographic hashes generated in step (i2) or step (i4) against the appropriate cryptographic hash of this ciphertext or plaintext data, as stored previously when the data was written,
(i6) if the comparison or comparisons of step (i5) match, then the inline storage protection device delivers the data on the data link, but
(i7) if either or both of the comparisons of step (i5) do not match, then the inline storage protection device does not deliver the data,
(j0) and for write operations on new data elements the following steps are taken,
(j1) optionally, the inline storage protection device computes a cryptographic hash of the plaintext data element and stores this value, but if this step is omitted, then step (j3) must occur,
(j2) using appropriate cryptographic methods, as common in the art, the inline storage protection device encrypts this data element,
(j3) optionally, the inline storage protection device computes an appropriate cryptographic hash of this data element of ciphertext data and stores this value, but if this step is omitted, then step (j1) must have occurred,
(j4) the inline storage protection device writes the data element to the storage device,
(k0) for write operations on existing data elements the following is done,
(k1) the inline storage protection device first executes a read operation as described at (i0) through (i7) in this claim, and
(k2) if this read operation executes without error, then the write proceeds as described in the write operation at (j0) through (j4) in this claim,
(k3) otherwise the write fails,
wherein the improvement comprises the enforcement by the inline storage protection device of policy for data use or attempted data use, and of auditing of data use or of attempted data use, at the point at which the data is cryptographically protected, such that on each attempted read operation, after the data have been decrypted but before they are presented externally to the inline storage protection device, and on each attempted write operation, before the data have been encrypted for presentation to the storage device,
(l1) the inline storage protection device applies a policy determined by one or more computer programs contained within it and all inputs available to these programs to determine whether it will satisfy the read or write request or refuse to satisfy it,
(l2) the inline storage protection device may or may not chose to generate auditing data to record the operation, as determined by one or more computer programs contained within it and all input available to these programs, such that
(l3) the auditing data thus gathered may be recorded on the inline service protection device itself, and also
(l4) if a control port is available on the inline service protection device, the auditing data thus gathered may be delivered through it to the external control facility, and also
(l5) if a control port is available on the inline service protection device, the auditing data thus gathered may be delivered through it to a third party as desired, and at all times
(l6) if the inline storage protection device contains a control port, the policy and auditing computer programs may be updated by the control facility over that port,
whereby
(m1) the inline storage protection device secures data in a manner employing not simply encryption but also cryptographic hashing, allowing detection of certain types of attacks on the data, and
(m2) the inline storage protection device cryptographically secures data in a conceptually uniform manner over a broader range of storage devices than the prior art, and
(m3) the inline storage protection device may be more securely and in an operationally advantageous manner enabled and disabled for operation, and
(m4) through the application of policy decisions at the point of cryptographic data protection the inline storage protection device protects data not only against external attackers but also against deliberate or accidental misuse or misappropriation by otherwise legitimate users, and
(m5) through the application of auditing recording at the point of cryptographic data protection and also the optional transmission of audit records to a control facility and also the optional transmission of audit records to third party auditors, the inline storage protection device allows detection of and reaction to improper use of data as such use is occurring, and
(m6) through the application of auditing recording at the point of cryptoraphic data protection, the inline storage protection device allows forensic analysis of improper use of data.

2. The inline storage protection device and inline storage protection device key of claim 1 wherein
(n1) the storage devices associated with the inline storage protection device are restricted so as to exclude sequential access storage devices and direct access storage devices,
(n2) the control port is not present on the inline storage protection device,
(n3) the inline storage protection device does not enforce data use policy, and
(n4) the inline storage protection device does not perform auditing,
whereby the inline storage protection device operates as a simple data encryption device as is known in the prior art in cases involving sequential access storage devices and direct access storage devices, except that it is extended to operate with other types of storage devices, including those, as described in this invention, not generally considered as conventional storage devices in the art.

3. The pair of devices of claim 1 or of claim 2, further including
(o1) a separate data and communications link from the inline storage protection device to an external data repository termed a coordinating storage facility, and
(o2) sufficient program logic within the inline storage protection device so that it maintains its protected storage device as effectively equivalent in content to a storage device maintained at the coordinating storage facility, and
(o3) sufficient program logic within the inline storage protection device so that, conversely, the storage facility may maintain a storage device as effectively equivalent in content to the storage device associated with the inline storage protection device,
where in operation
(p1) a plurality of pairs of these devices are deployed such that each operates in coordination with a single external coordinating storage facility such that, by virtue of coordinating their storage devices each with a single external coordinating storage facility, individually and collectively they maintain the contents of their said protected storage devices as effectively equivalent to the contents of the coordinating storage facility,
whereby each user of an inline storage protection device so deployed therefore has in its storage device data identical to the storage devices of the coordinating storage facility and all other users participating in this deployment, in such a way that
(q1) no user may compromise the data of another user without affecting the whole, as each storage device is protected by a separate inline storage protection device and therefore encryption unique to it, and
(q2) the loss of one or a plurality of inline storage protection devices and their associated storage devices will not compromise the security of the remaining devices, as each storage device is protected by a separate inline storage protection device and therefore encryption unique to it.
